(19) United States
(12) Patent Application Publication
(10) Pub. No.: US 2017/0116631 A1
(43) Pub. Date: Apr. 27, 2017

(54) SYSTEMS AND METHODS FOR DYNAMICALLY SETTING VALUES IN A COMPUTING SYSTEM BASED ON SCANNING OF MACHINE-READABLE REPRESENTATIONS ASSOCIATED WITH PHYSICAL OBJECTS

(71) Applicant: Wal-Mart Stores, Inc., Bentonville, AR (US)

(72) Inventors: Madhur Sarin, Bangalore (IN); Ken Slater, Oswaldtwistle (GB)

(21) Appl. No.: 14/961,363

(22) Filed: Dec. 7, 2015

(30) Foreign Application Priority Data
Oct. 22, 2015 (IN) 3425/DEL/2015

(51) Int. Cl. G06Q 30/02; G06F 17/30

(52) U.S. Cl. CPC G06Q 30/0206; G06Q 30/0205; G06F 17/30879

(57) ABSTRACT

Exemplary embodiments are directed to dynamically reconfiguring parameter values based on scanning or otherwise receiving entry of an identifier associated with physical objects. A value of a parameter associated with physical objects is determined for a first time period at one or more geographic locations and the value is stored in a first database. An identifier is scanned and/or entered into a computing device. Information related to a quantity of times the identifier is scanned and/or entered is recorded in a second database. A rate at which the identifier is scanned and/or entered during the first time period is analyzed. When the rate is less than a specified rate, a subsequent value of the parameter and a second time period for setting the subsequent value is determined based on a predicted response to the subsequent value, and the value in the first database is replaced with the subsequent value for the second time period.

### RELATED APPLICATION

This application claims benefit of and priority to Indian Patent Application No. 3425/DEL/2015 filed on Oct. 22, 2015, the entire contents of which are incorporated herein by reference in its entirety.

### BACKGROUND

In conventional computing systems, parameter values associated with physical objects are generally applied according to tables storing predefined parameter values or as per pre-defined/pre-existing attributes for the physical objects, such that the parameter values generally are not updated and are static. They are not replaced or updated based on real time attribute values that are made known through physical interactions between a computing system and machine-readable representations associated with the physical object.

### BRIEF DESCRIPTION OF DRAWINGS

Some embodiments are illustrated by way of example in the accompanying drawings and should not be construed to limit the present disclosure:

FIG. 1 is a block diagram showing a dynamic value calculation tool implemented in modules, according to an example embodiment;

FIG. 2 is a flowchart showing an example method for dynamically reconfiguring parameter values based on scanning of an optical machine-readable identifier associated with physical objects, according to an example embodiment;

FIG. 3 depicts an example system for setting the first parameter value for a physical object in a computing system, according to an example embodiment;

FIG. 4 depicts an example system for replacing a set parameter value for a physical object in a computing system with subsequent parameter values for the physical object in the computing system, according to an example embodiment;

FIG. 5 depicts an example system dataflow for determining the first parameter value for a physical object, according to an example embodiment;

FIG. 6 depicts an example system dataflow for determining subsequent parameter values for a physical object, according to an example embodiment;

FIGS. 7A and 7B depict flowcharts illustrating an example process for setting a first parameter value for a physical object, according to an example embodiment;

FIGS. 8A and 8B depict flowcharts illustrating an example process for replacing a set parameter value for a physical object in a computing system with subsequent parameter values for the physical object in the computing system, according to an example embodiment;

FIG. 9 schematically illustrates an example Bayesian network for dynamically determining a parameter value for a physical in a computing system, according to an example embodiment;

FIG. 10 illustrates a network diagram depicting a system for implementing the dynamic value calculation tool, according to an example embodiment; and

FIG. 11 is a block diagram of an exemplary computing device that may be used to implement exemplary embodiments of the dynamic value calculation tool described herein.

### DESCRIPTION OF EXEMPLARY EMBODIMENTS

Described in detail herein are systems, methods, and computer readable medium for dynamically reconfiguring parameter values based on scanning of an optical machine-readable identifier associated with physical objects and/or receiving entry of one or more identifiers associated with the physical objects into a computing system. Example embodiments provide for determining a value of a parameter associated with physical objects where the value of the parameter is stored in a first database and is associated with physical objects for a first time period at one or more specified geographical locations, scanning an optical machine-readable identifier associated with the physical objects or receiving entry of one or more identifiers associated with the physical objects during the first time period where the value of the parameter is retrieved from the first database in response to the scanning (receiving entries), recording in a second database information related to a quantity of times the optical machine-readable identifier is scanned (or entered) at the one or more geographical location during the first time period, retrieving the information recorded in the second database for the first time period, analyzing a rate at which the optical machine-readable identifier was scanned or identifiers were entered during the first time period based on the information, and when the rate is less than a specified rate, determining a subsequent value of the parameter and a second time period for which the parameter is to be set to the subsequent value, both are based at least in part on a predicted response to the subsequent value at the one or more geographic locations during the second time period, and then replacing the value with the subsequent value in the first database for the second time period.

In some embodiments, the parameter value is a for a current data value associated with the physical objects, and the subsequent value of the parameter is a different new data value for the physical objects. In some embodiments, the optical machine-readable identifier is a barcode associated with the physical objects that indicates the current data value of the item. In some embodiments, analyzing a rate at which the optical machine-readable identifier is scanned during a time period includes analyzing the rate at which the identifier is scanned based on the number of times the barcode associated with the physical objects is scanned at a geographic location. The systems and methods described here may be implemented as a dynamic value tool. While embodiments may described with reference to the markdown environment, exemplary embodiments of the present disclosure can be applied in any suitable environment that provides for dynamic reconfiguration parameter values in a computing system.

In some embodiments, the systems and methods described herein can be applied to one or more environments. One non-limiting example environment can include a markdown environment to help to reduce costs due to reduction of product waste through greater optimization of the markdown calculation for increased sales. The dynamic value tool has the ability to compute and set an optimized markdown value that can be item-store specific and can be applied at a predefined, store-department specific times or on ad-hoc basis as requested by a store associate at any desired time. The dynamic tool can be a dynamical markdown tool that works in conjunction with any department-chain level reductions. The tool also allows for the centralized processing of bulk markdowns to accommodate peak consumer activity changes. The dynamic markdown calculation tool generates a real-time item-store specific, optimised markdown value.

The dynamic markdown calculation tool takes into consideration promotional events, such as bundled items (for example, buy 2 for the price of 1) in the optimized markdown calculation. The tool also takes into consideration variable weight items that are sold based on their weight in the optimized markdown calculation. The tool also accounts for product sales forecast (based on historic data) and inventory levels in the optimized markdown calculations

The tool is designed so that it can be centrally maintained and provides the ability to efficiently change any of the key parameters incorporated within the markdown calculation, and can generate relevant management information to support markdown decision and strategies. The tool enables generation of new price labels incorporating both the new markdown price and the original price, which provides improved visibility to customers on their receipts of what marked down items they have purchased.

The tool is designed to identify the original cost of an item when it is reduced and then sold as a marked down item. The tool identifies loss as a difference between an original retail price and a price for which the item is sold, and accounts for this loss when a markdown is applied. The tool enables various stages or iterations of markdowns (1st, 2nd etc.) to impact inventory and replenishment processes in line with business strategy.

The systems and method herein also provide analytics generated from and for, the markdown process and calculation. At a high-level, the relative success of any markdown strategy can be gauged and where feasible, key metrics, forecasts and conclusions can be fed back into the dynamic markdown calculation tool. The utilization of historic markdown, waste and sales data is used to train the tool and can also assist in defining related business strategies.

The markdown calculation is the process for generating a price reduction for an expiring, or damaged item. An over-arching business need in this respect is to generate a real-time, item-store specific, optimised markdown price value to minimize waste and maximize revenue.

Traditional markdown systems calculate markdown values using a rule-based system without regards to item or store data. However, the dynamic value calculation tool calculates markdown values based on real-time data relating to item behaviour and store behaviour. Exemplary embodiments of the present disclosure provide for self-educating/self-learning system to calculate optimal markdown price based on factors such as, store specific product sales and product inventory levels (perpetual inventory), and historic success rate of selling reduced items to ensure marked down items achieve the best possible optimum selling price.

Exemplary embodiments of the dynamic markdown calculation tool described herein may use one or more of the following data elements to determine a markdown (parameter) value:

| ELEMENT | FACTOR | IMPACT |
|---|---|---|
| Time | Time before the ‘Waste | The number of hours/minutes left to try to sell |
| | Deadline’ | the item. |
| | Time before the store closes | The number of hours/minutes left before the |
| | | store closes. |
| Date | Public holidays | Planned public holidays impacting store |
| | | opening hours. |
| | Closed days (and proximity | Planned and enforced store closure and the |
| | to) | days leading up to the closure. |
| | Ad-hoc events | Impact on both opening hours and general |
| | | sales impact. |
| Day of | Historic data | Using same day historic data to factor into |
| week | | future calculations. |
| Item | Individual item | Assessing the item individually in terms of any |
| | | rules. Example damage, severity etc. |
| | Item type classification | Assessing the item in terms of any groups/ |
| | | departments it is associated to (e.g. bundled |
| | | items, variable weight). |
| | Similar items | Assessing the item in line with other pre- |
| | | identified, similar items. |
| Store | Markdown quantity | The number of items being marked down. |
| | Inventory levels | The total number of items in stock in the store |
| | | (and total number of similar items). |
| | Store format and type | The store format (or sub-group of) and any |
| | | configured comparative store groupings. |
| | New store | Sourcing comparative historic and base data |
| | | for new stores. |
| | Temporary closure/ | Factoring in ad-hoc store disruption. |
| | disruption | |
| | Supply issues | Factoring item/store and generic supply issues |
| | | into the MD calculation. |
| | Competitor impact | Factoring in the impact of competitors opening |
| | | new stores. |
| | Weather | Local weather potentially impacting customer |
| | | choice/shopping habits. |
| | Product-Store Seasonality | Rate of sale during a particular season at the |
| | | store for an item |
| | Item-store elasticity | Price response curves taking into consideration |
| | | historic price versus volume sale data |
| | Store overrides | Input from associate or manager at the store |

As used herein, “store format” refers to a group of stores based on similar characteristics of the stores, such as, location, size, type of product sold, and the like. Non-limiting examples of a store format include supercenters, superstores, supermarkets, convenience store, etc.

As used herein, “item” refers to any physical object or product sold by a business.

As used herein, “bundled items” or “bundling” refers to items that are on promotion with another item, for example, buy 3 for the price of 2.

As used herein, “catch weight items” refers to items that are sold based on weight.

As used herein, “promotion” refers to items sold for a discount or reduced price.

As used herein, “items in the bin” refers to product that has been wasted without being marked down.

As used herein, “markdown items” refers to product that has been marked down. As used herein, “wasted items” refers to product that has been marked down, but is not sold and is ultimately wasted.

As used herein, “waste” refers to the retail value which is lost to the business as a result of an item either being marked down (difference between new marked down sale price and previous selling price) or when the item is thrown out without selling because of an expiration date or past a deadline to sell.

The following description is presented to enable any person skilled in the art to create and use a computer system configuration and related method and article of manufacture to dynamically reconfigure parameter values based on scanning of an optical machine-readable identifier associated with physical objects or receiving entry of one or more identifiers into a point-of-terminal. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

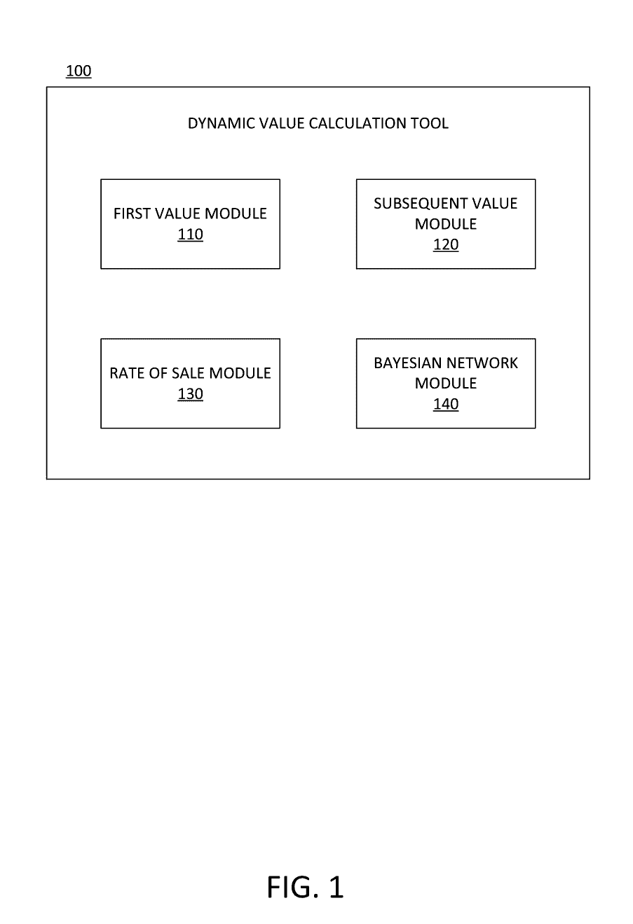

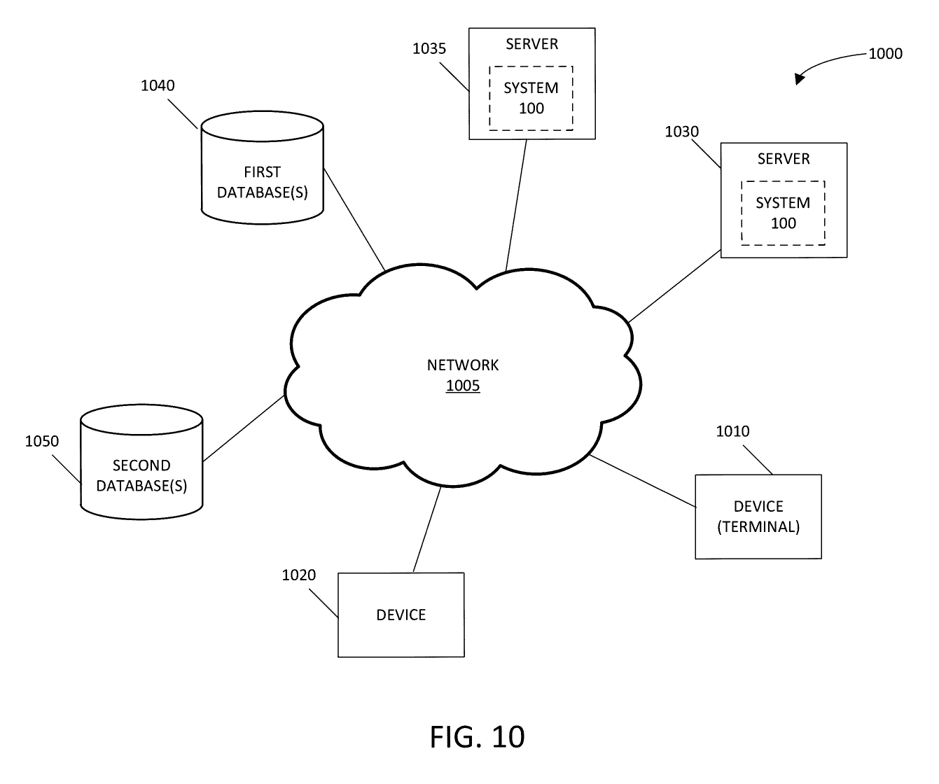

FIG. 1 is a block diagram showing a dynamic value calculation tool 100 in terms of modules according to an example embodiment. The modules may be implemented in devices 1010, 1020 shown in FIG. 10 The modules include a first value module 110, a subsequent value module 120, a rate-of-sale module 130, and a Bayesian Network module 140. The modules may include various circuits, circuitry and one or more software components, programs, applications, apps or other units of code base or instructions configured to be executed by one or more processors included in devices 1010, 1020. In other embodiments, one or more of modules 110, 120, 130, 140 may be included in servers 1030, 1035, while other of the modules 110, 120, 130, 140 are provided in the device 1010, 1020. Although modules 110, 120, 130, and 140 are shown as distinct modules in FIG. 1, it should be understood that modules 110, 120, 130, and 140 may be implemented as fewer or more modules than illustrated. It should be understood that any of modules 110, 120, 130, and 140 may communicate with one or more components included in system 1000 (FIG. 10), such as database(s) (e.g., database(s) 1040, 1050), servers (e.g., servers 1030, 1035), or devices (e.g., devices 1010, 1020).

The first value module 110 may be a hardware-implemented module that may be configured to calculate and generate a first value of the parameter or first markdown price value for one or more items by store at any given time. The subsequent value module 120 may be a hardware-implemented module that may be configured calculate and generate the subsequent value of the parameter or the subsequent markdown price value for the items by store any pre-configured time of the day or at any time markdown price is requested by store associate. The rate-of-sale module 130 may be a hardware-implemented module that may be configured to record information related to a quantity of times an optical machine-readable identifier related and unique to each individual product is scanned on the point of sale, and to analyze a rate at which the identifier was scanned for a predefined and configurable period of time (example every 15 minutes, 30 minutes, 1 hour, 2 hour etc. intervals). The Bayesian Network module 140 may be a hardware-implemented module that may be configured to implement a Bayesian Network algorithm to also determine a first value of the parameter or the first markdown value for an item.

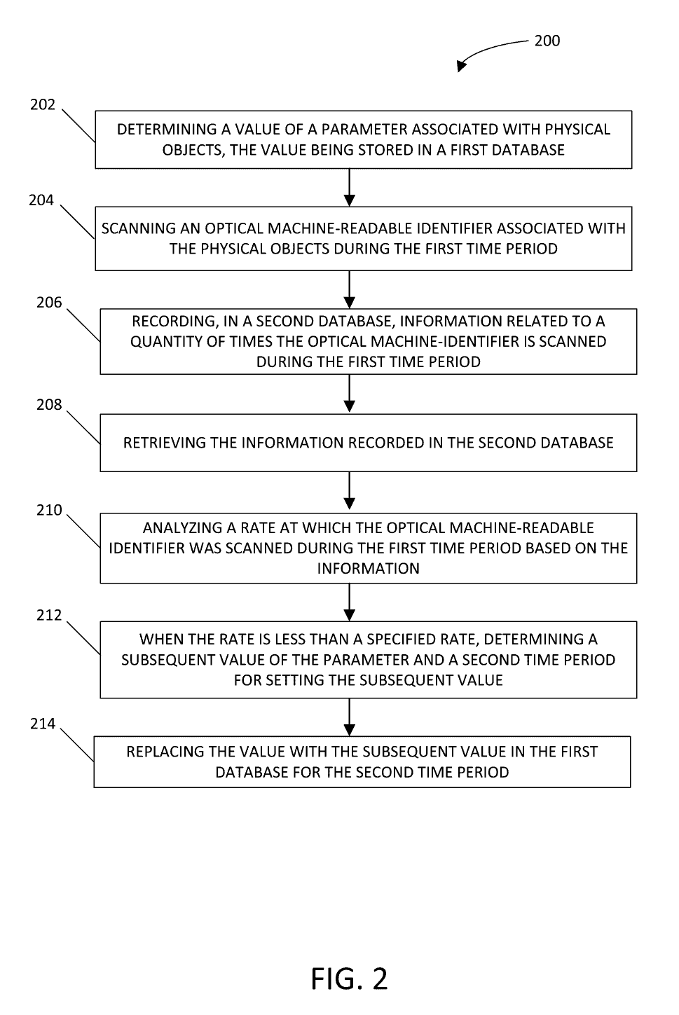

FIG. 2 is a flowchart showing an example method for dynamically reconfiguring parameter values based on scanning of an optical machine-readable identifier associated with physical objects and/or entry of one more identifiers associated with the physical objects. The method 200 may be performed using the modules in the dynamic value calculation tool 100 shown in FIG. 1.

At block 202, the first value module 110 determines a value of a parameter (e.g., a markdown value) associated with physical objects, where the value is stored in a first database and is associated with the physical objects for a first time period at one or more specified geographic locations. A time period is generally some portion of the day, and the time period, as used herein, can vary day to day, and may be different for an individual store. In some embodiments, the value of the parameter is determined by a server, for example, servers 1030 or 1035 shown in FIG. 10. In an example embodiment, the Bayesian Network module 140 determines the value of the parameter using a Bayesian Network algorithm, as discussed below. The Bayesian Network algorithm may be based at least in part on historical values of the parameter for the past time periods that correspond to the first time period, a historical quantity of times the optical machine-readable identifier was scanned during the past between two time periods, specific events for example Easter, Christmas, bank holidays etc., dates of specific events, and demographical features of the one or more geographic locations. In an example embodiment, the value of the parameter is determined using the Bayesian Network algorithm when the historical quantity of times the optical machine-readable identifier was scanned and/or identifiers are entered is not available for past time periods. The value of parameter determined at block 202, may be the first value of the parameter for a particular time period. For example, the value determined at block 202 may be the first markdown price for the physical objects for the day.

At block 204, the optical machine-readable identifier associated with the physical objects is scanned or entry of one or more identifiers is received during the first time period, and the value of the parameter is retrieved from the first database in response to the scanning or entry. In some embodiments, the scanning is done by one or more terminals including an optical scanning device at the one or more geographic locations. For example, the optical machine-readable identifier may be scanned by an optical reader at a point-of-sale terminal or using a hand held device.

At block 206, the rate-of-sale module 130 records, in a second database, information related to a quantity of times the optical machine-readable identifier is scanned and/or identifiers are entered into the point-of-sale terminal at the one or more geographic locations between two time periods. For example, the rate-of-sale module 130 records the quantity of times an identifier is scanned and/or entered at a point-of-sale terminal at a geographic location to determine the number of physical objects sold between time intervals. At block 208, the rate-of-sale module 130 retrieves the information recorded in the second database.

At block 210, the rate-of-sale module 130 analyzes a rate at which the identifier was scanned and/or entered during the first time period based on the information retrieved at block 208. For example, the rate-of-sale module 130 determines the rate-of-sale for the physical objects. In an example embodiment, the rate-of-sale module 130 compares the analyzed rate-of-sale to a predefined or specified rate-of-sale for the physical objects.

At block 212, when the rate analyzed at block 210 is less than the specified rate, the subsequent value module 120 determines a subsequent value of the parameter (e.g., a subsequent markdown value) and a second time period for which the parameter is to be set to the subsequent value. For example, the subsequent value module 120 can adjust the price of the physical objects to increase the likelihood of selling the physical objects at the specified rate.

The subsequent value of the parameter and the second time period can be determined based at least in part on a predicted response to the subsequent value at the one or more geographical locations during the second time period. In an example embodiment, the subsequent value is based at least in part on a percentage by which the subsequent value exceeds a cost to acquire one of the physical objects, a deadline by which the objects must be removed from a display area at the one or more geographic locations, and operating hours of the one or more geographic locations. In an example embodiment, the subsequent value and the second time period are determined based at least in part on a labor cost of printing and managing price labels for the physical objects.

In an example embodiment, the predicted response is based at least in part on a historical rate at which the identifier (e.g., optical machine-readable identifier) was scanned or entered when the value of the parameter was set to at least one of the previous value, the first value, the subsequent value, or a further subsequent value. In an example embodiment, the predicted response is based at least in part on a historical rate at which the identifier was scanned or entered at the one or more geographic locations and demographics of individuals that visit the one or more geographic locations.

The subsequent value determined at block 212 may be the second value for the parameter for a particular time period. For example, the subsequent value determined at block 212 may be the second price for the physical objects for the day, where the second price may be markdown from the first price of the physical objects that was determined at block 202.

At block 214, the subsequent value module 120 replaces the value of the parameter with the subsequent value in the first database for the second time period.

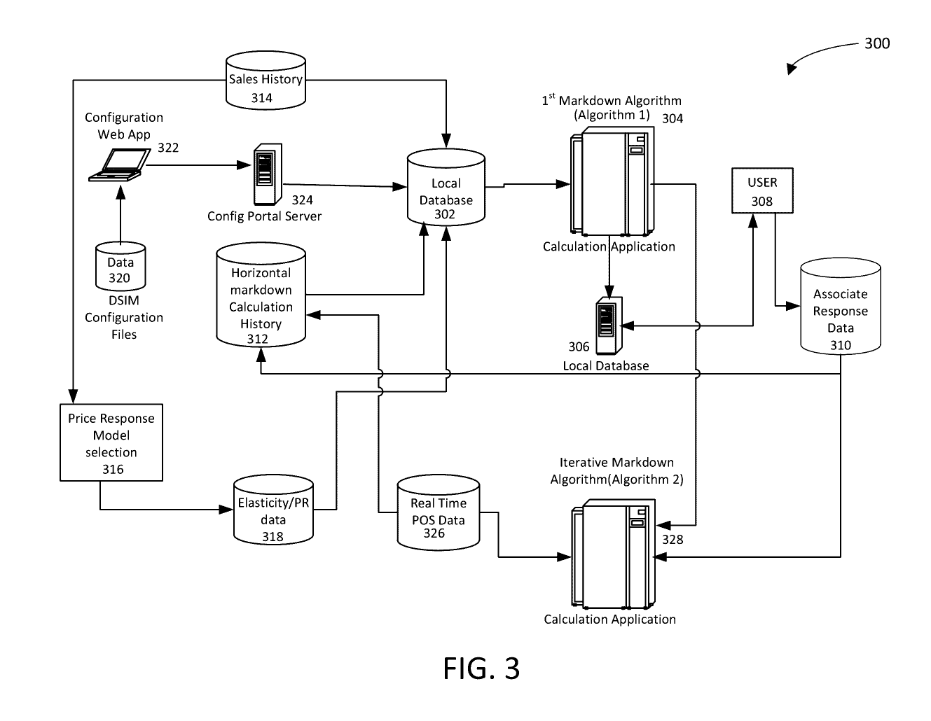

FIG. 3 depicts an example system 300 for calculating the first markdown (parameter) value for a physical object. The system 300 may include interactions between local database 302, a first calculation application 304, a second calculation application 328, smart tables 306, user 308, associate response data 310, horizontal history database 312, sales history database 314, price response model selection database 316, configuration portal 324, and real-time POS database 326.

The local database 302 may be configured to store data to facilitate calculations and generation of values of the parameter according to methods described herein, and may be updated daily with data. The first calculation application 304 may be configured to calculate the first markdown (parameter) value for an item using data stored in the horizontal history database 312. The horizontal history data base 312 feeds the local database, combined with real time sales history database 314 and configuration portal 324. The first calculation application 304 is configured to calculate the first markdown parameter value for an item store combination using the data assimilated in local database 302. The first calculation application 304 may run daily to generate values for the parameter. The second calculation application 328 may be configured to calculate the subsequent markdown (parameter) value for an item, and to interface with the first calculation application 304. The second calculation application 328 may run hourly to iteratively generate values for the parameter. The local database 306 may be configured to store the first markdown (parameter) value generated by the first calculation application 304. In some embodiments, the user is able to access the value of parameter by accessing the local database 306 via a hand-held or mobile user device.

User 308 may provide, via a user device, the associate response data 310 indicating the user's response or feedback to the markdown (parameter) value calculated by the first calculation application 304. The user may choose to accept or reject the recommendation of the markdown value price generated by the application 304 and may have the ability to override it. The associate response data 310 may be stored in the horizontal history database 312. The horizontal history database 312 may be configured to store data related to historical values of the variables used to estimate the first markdown (parameter) value for an item store combination. The variables include, but are not limited to, time slots for updating the markdown value, historical first markdown percentage, day of the week, week of the month, month, list of public holidays, list of special events (for example, Easter), historical dates of the special events, demographic details based on the store location, quantity of items for historical first markdown, time for historical first markdown, and sale quantity for historical first markdown, item seasonality. The historical history database 312 may be updated daily. The sales history database 314 may be configured to store historic point-of-sale data, and may be updated hourly. The price response model selection 316 may be configured to select item—store specific price response models, and may be updated monthly. The information from the price—response model selection is stored in elasticity/PR database 318 and includes, but is not limited to, price, cost, normalized volume, sales, item-store elasticity, inflation and time.

The configuration portal 324 may be configured to process and store information for special cases based on settings configured by an entity or a governing entity. The real-time POS database 326 may be configured to store for recalibrating forecasting models used for calculating subsequent markdown (parameter) values based on data retrieved from POS systems on an hourly basis. The real-time POS database 326 may store sales information based on item-store combinations.

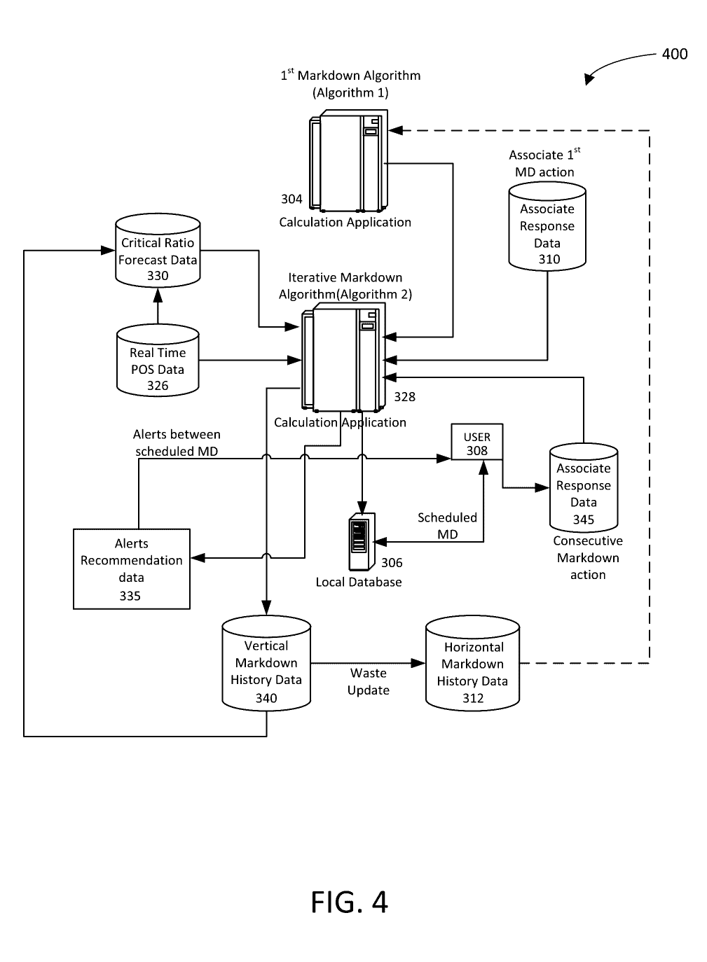

FIG. 4 depicts an example system 400 for calculating subsequent markdowns or subsequent parameter values for a physical object. The system 400 may include interactions between the first calculation application 304, second calculation application 328, local database 306, user 308, associate response data 310 for the first markdown, associate response data 345 for subsequent markdowns, real-time POS data 326, critical ratio forecast data 330, alert recommendation database 335, and vertical markdown history database 340.

The first calculation application 304, the second calculation application 328, the local database 306, and the associate response data 310 may be configured to perform the functionalities as discussed in connection with system 300 of FIG. 3. The critical ratio forecast database 330 may be configured to store exponentially calibrated critical ratio forecast data, and may be updated daily. The data stored in the critical ratio forecast database 330 includes, but is not limited to, exponential calibration constant, POS data, and vertical history, item—store—hourly level critical ratios, limiting ratios. The alert recommendation database 335 may be configured to store and generate alerts at item-store level based on end of day forecast, and may be updated hourly. The alerts are generated between scheduled markdown times in a day for items that require recalibration to markdown price value based on the received/realized rate of sale, specified rate of sale and end of day sale forecast. This allows for stores to give subsequent markdown before the scheduled time. The vertical markdown history database 340 may be configured to store information to estimate customer response towards markdown price based on the rate of sale from the first markdown of the item until the waste deadline of the item. The vertical markdown history database 340 may be updated hourly, and may be used to adjust the markdown price for the n-th iteration of markdowns. The vertical markdown history database 340 includes, but is not limited to, original price, first markdown price, markdown quantity, time stamp of the first markdown, rate of sale, alerts available time, n-th iteration markdown price, n-th iteration markdown quantity, and the operating hours of the store. User 308 may provide, via a user device, the associate response data 345 indicating the user's response or feedback to the subsequent markdown (parameter) value calculated by the second calculation application 328. The user may choose to accept or reject the recommendation of the markdown value price generated by the application 304 and may have the ability to override it.

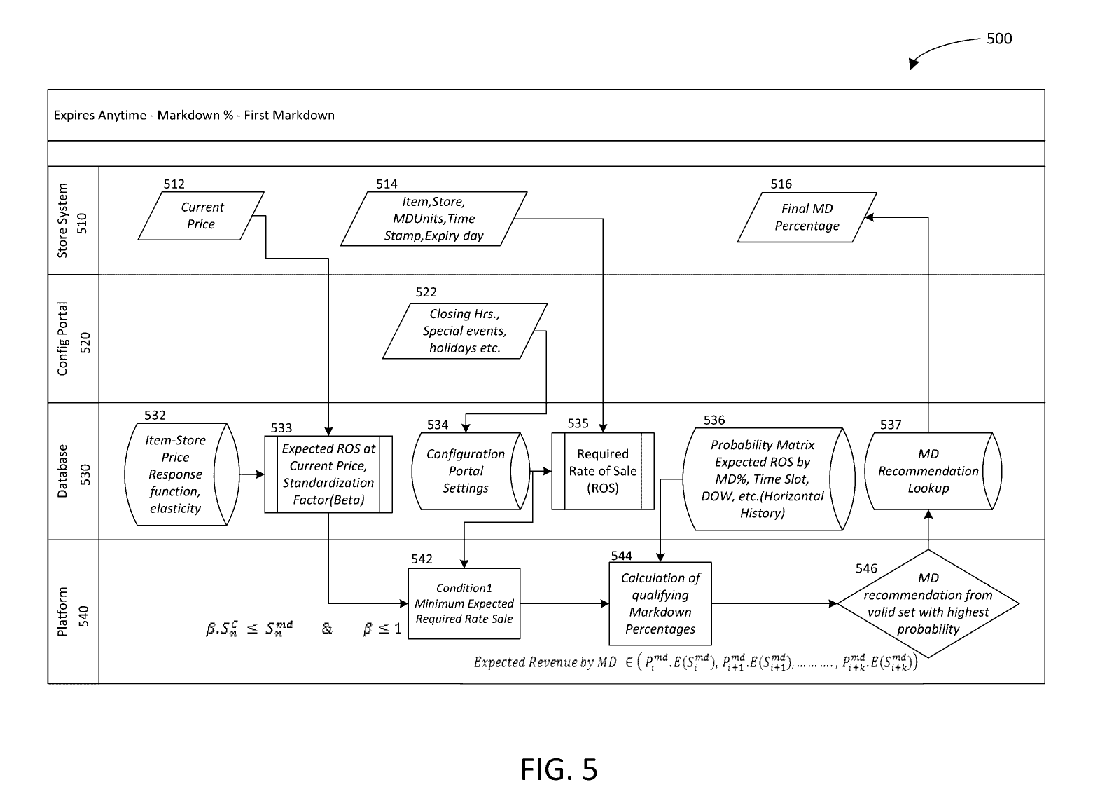

FIG. 5 depicts an example system dataflow 500 for calculating the first markdown (parameter) value for a physical object. The store system 510 associated with the one or more geographic locations, provides the current price 512 and other information 514 related to item, store, markdown units, time stamp of markdown, and expiry day of items to database 530. The config portal 520 provides information 522 specific to the store, such as, closing hours of the store, special events, holidays, and the like, to the database 530. The database 530 stores information 532 relates to price response functions at an item-store level, the price response function is a relationship between price and volume for an item store combination. The database also stores the elasticity of the item—store combination. At block 533, the current price 512 and information 532 is used to calculate the expected rate-of-sale for an item at the specific store when sold at the current price 512. At block 535, a required (specified) rate-of-sale is determined using information 514, along with configuration portal settings 534. Horizontal history data 536, including a probability matrix of an expected rate-of-sale for a percentage markdown, a corresponding time period, and the like, is provided to the platform 540 at block 544.

The expected rate-of-sale and required rate-of-sale is provided to platform 540. At block 542, based on condition 1 (discussed in detail below), the minimum expected rate-of-sale is calculated. At block 544, qualifying markdown percentages are calculated (discussed in detail below). At block 546, the platform 540 provides a markdown recommendation, to database 530, from a valid set of calculated markdowns at block 544 based on the highest probability of revenue generation. The database 530 provides the final markdown percentage 516 to the store system 510.

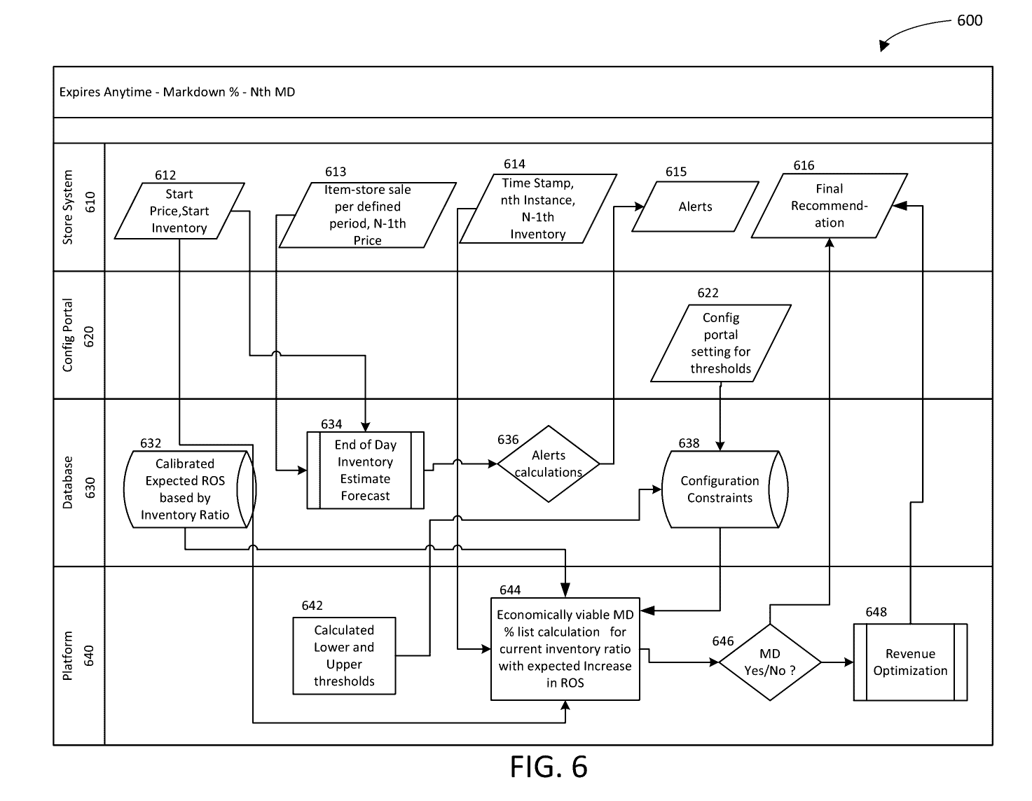

FIG. 6 depicts an example system dataflow 600 for calculating subsequent markdown (parameter) values for a physical object. The store system 610 provides information 612 including a starting price for an item and the starting inventory for the item to the platform 640. The store system 610 also provides information 613 including the previous price of the item before the current markdown, and the number of items sold during under the previous price. The store system 610 also provides information 614 including time stamp for the current time period, and the inventory level at previous time period. The config portal 620 provides configuration portal settings 622 for thresholds to database 630.

At block 630, the database 632 stores calibrated expected rate-of-sale based on the inventory ratio, and provides this data to the platform 640. At block 634, the end of day inventory is estimated or forecasted based on information 612 and 613 provided by the store system 610. At block 636, alerts are calculated based on inventory forecasts. The platform 640 provides lower and upper thresholds to be used in the dynamic value calculation tool at block 642. At block 644, the platform 640 determines economic viable markdown percentages for current inventory ratio with an expected increase in the rate-of-sale using configuration constraints 638, calibrated expected rate-of-sale 632, information 612 and information 614. At block 646, the platform 640 determines whether a markdown should be applied or not, based on whether an economically viable markdown price is valid for the item store combination at that point of time in the day. If only single economically viable markdown is possible for the item—store combination at that point then, this markdown price value is recommended to block 616 part of store system 610. If multiple markdown price values options are economically feasible at a given time then at block 648, that markdown price recommendation for the item—store combination that maximizes revenue is provided to the store system 610.

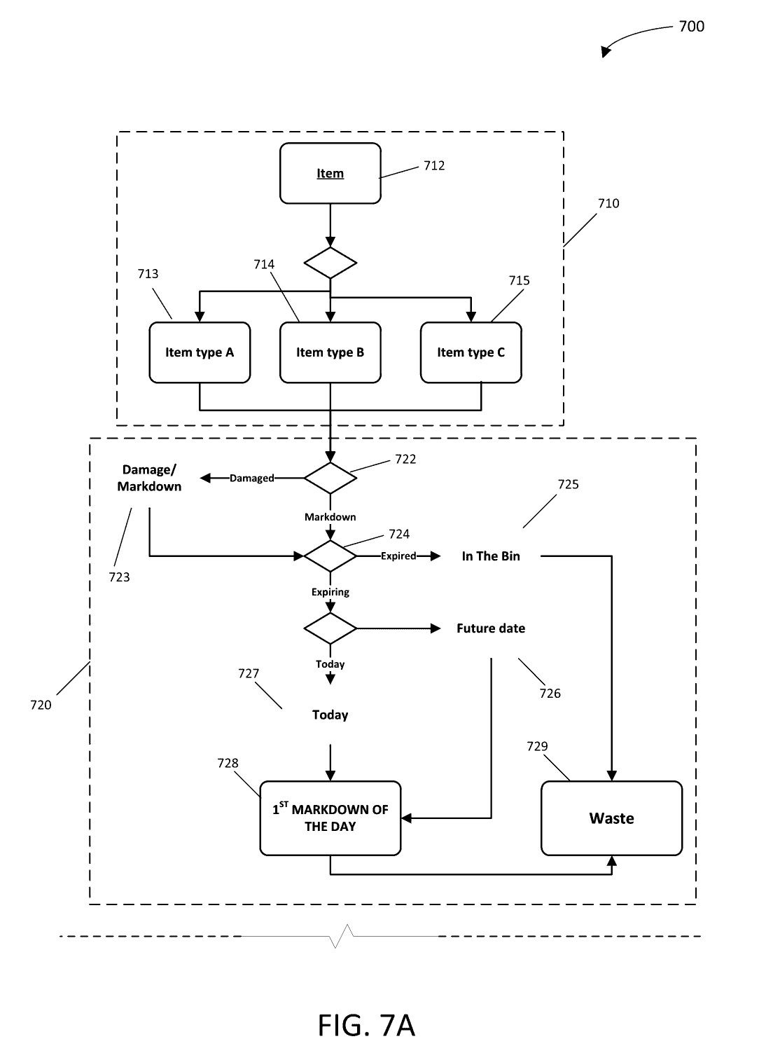

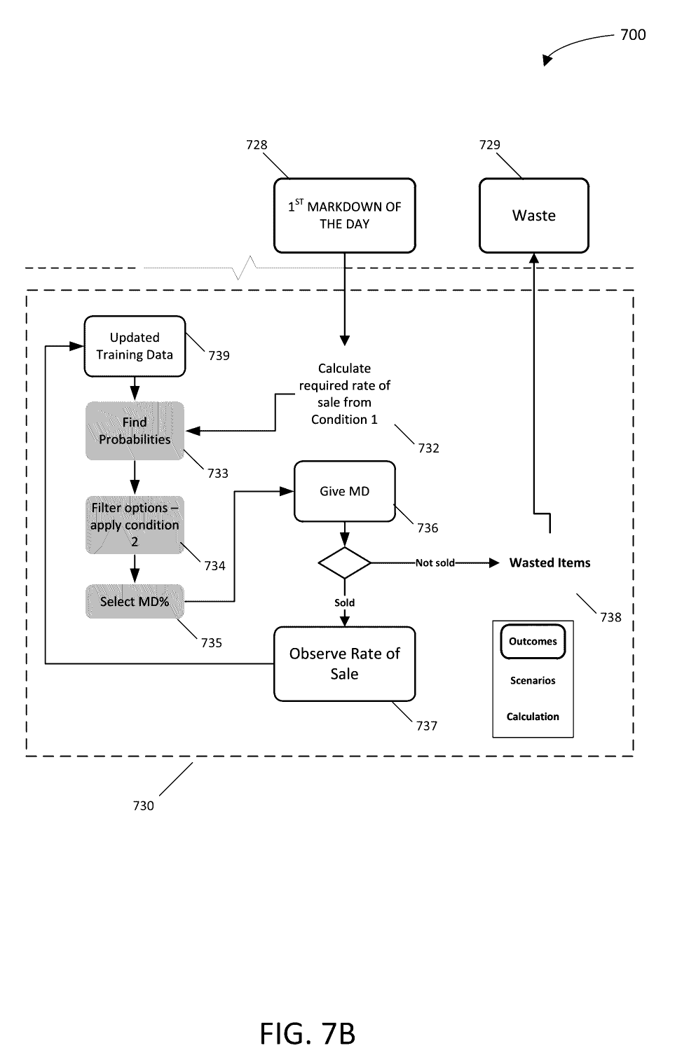

FIGS. 7A and 7B depict flowcharts 700 illustrating an example process for determining a first markdown (parameter) value for a physical object. In block 710, the physical object/item 712 is classified into an item type, for example, item type A 713 (fresh items or produce), item type B 714 (general merchandize), or item type C 715 (clothing). The item type may classify the item based on the characteristics of the item, such as, shelf-life or department that it is sold under. The item type may be assessed when an identifier associated with the physical object is scanned by or entered in a point-of-sale terminal.

In block 720, a markdown type is determined at block 722 based on the characteristics of the physical object. For example, the physical object may be a damaged item and may be assessed for a damaged item markdown at block 723. As another example, the physical object may be due to expire soon and may be assessed for a normal markdown at block 724. In another example, the physical object may have expired already, and is classified as “waste in the bin” at block 725. In yet another example, the physical object may be expiring at a future date, and is classified accordingly at block 726. In some embodiments, the first markdown (parameter) value for the physical object is determined at block 728. In other embodiments, such physical objects may be considered for markdown at a later time, for example, closer to its expiration date. In another example, the physical object may be expiring today, and is classified accordingly at block 727, and the first markdown (parameter) value of the day for the physical object is determined at block 728. If the markdown physical object is not sold by a waste deadline, then the physical object is classified as waste at block 729.

At block 730, an example of the markdown value is calculated for the item using a Bayesian Network algorithm. The required rate-of-sale is calculated at block 732 based on condition 1 (discussed in detail below). Using a Bayesian Network algorithm, probabilities for an expected rate-of-sale for a markdown price is determined at block 733. The probabilities are filtered at block 734 based on condition 2 (discussed in detail below), and a markdown percentage is selected at block 735. The actual rate-of-sale of the item based on the markdown price is observed at block 737, and used to train the Bayesian Network algorithm at block 739. The physical object may be classified as wasted items at block 738 if the physical object is not sold after a markdown in price.

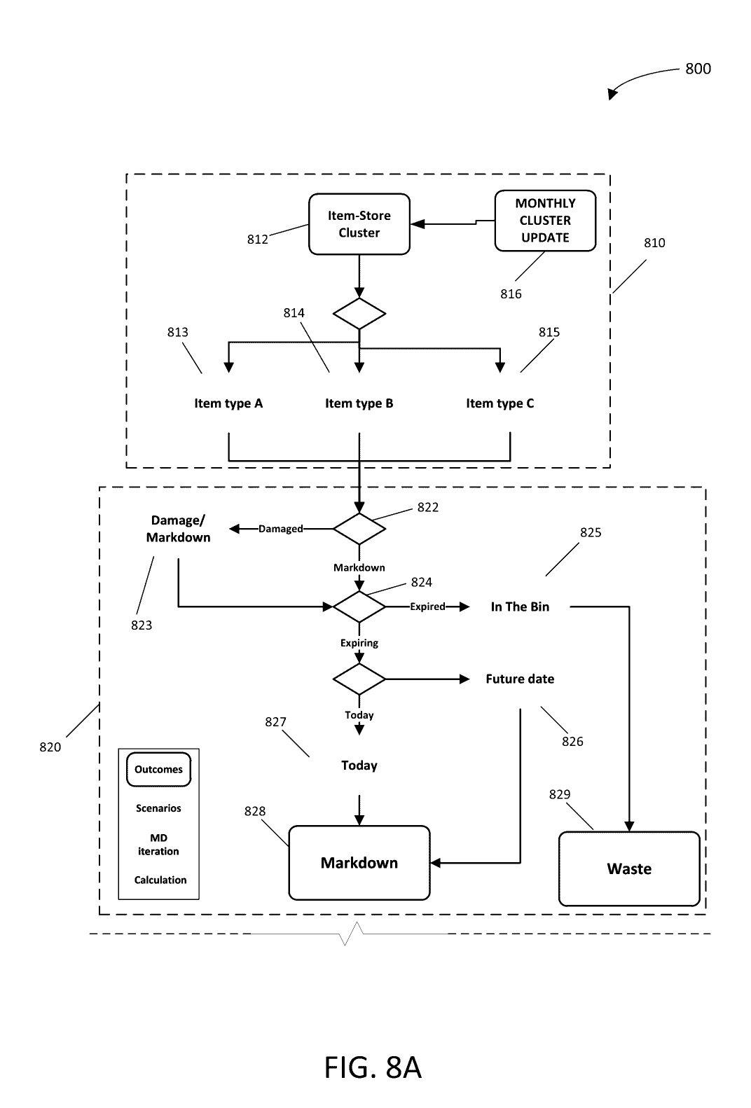

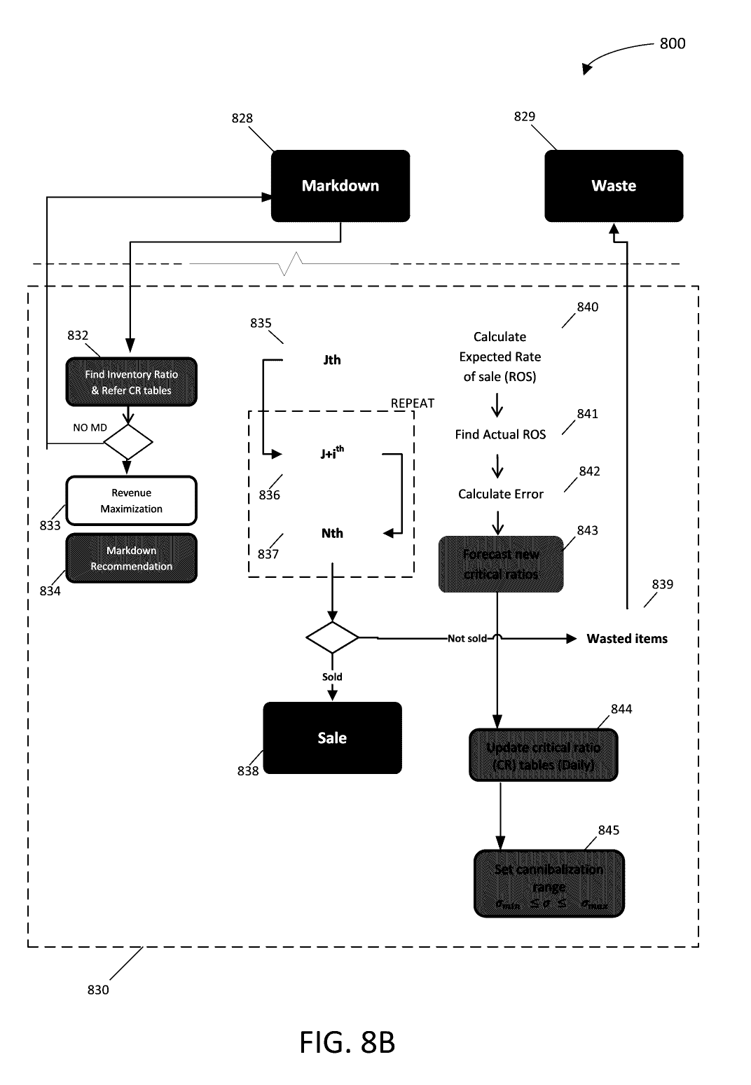

FIGS. 8A and 8B depict flowcharts 800 illustrating an example process for calculating subsequent markdowns or subsequent parameter values for a physical object. In block 810, the physical object/item 812 is classified into an item type, for example, item type A 813, item type B 814, or item type C 815. The item type may classify the item based on the characteristics of the item, such as, shelf-life or department that it is sold under. The item type may be assessed when the physical object is scanned. The item-store cluster information may be updated on a monthly basis at block 816 and new item and stores are added.

In block 820, a markdown type is determined based on the characteristics of the physical object. For example, the physical object may be a damaged item and may be assessed for a damaged item markdown at block 823. As another example, the physical object may be due to expire soon and may be assessed for a normal markdown at block 824. In another example, the physical object may have expired already, and is classified as “waste in the bin” at block 825. In yet another example, the physical object may be expiring at a future date, and is classified accordingly at block 826. In some embodiments, the first markdown for the physical object is determined at block 828. In other embodiments, such physical objects may be considered for markdown at a later time, for example, closer to its expiration date. In another example, the physical object may be expiring today, and is classified accordingly at block 827, and the first markdown of the day for the physical object is determined at block 828. If the markdown physical object is not sold by a waste deadline, then the physical object is classified as waste at block 829.

In block 830, a subsequent markdown (parameter) value is calculated using an algorithm discussed below (see Methodology to Estimate Nth Markdown Parameter value). The expected rate-of-sale and the actual rate-of-sale are determined at blocks 840 and 841. The error between the expected and actual rate-of-sale is determined at block 842, and a new critical ratio is forecasted at block 843. The database is updated with the new critical ratio on a daily basis at block 844. The cannibalization range is set, as discussed in detail below, at block 845. The calculation of a subsequent markdown (parameter) value is repeated for a physical object until it is sold at blocks 835, 836 and 837. If the physical object is not sold at block 838 before a deadline, then it is classified as wasted items at block 839. In determining the markdown (parameter) value, the critical ratio is retrieved from the database at block 832. Revenue maximization factors are determined at block 833, and a markdown (parameter) value is recommended at block 834.

### Methodology to Estimate 1^{st} Markdown Parameter Value Using Bayesian Network

The functionalities described below may be implemented in one or more components of system 700 shown in FIGS. 7A and 7B.

In example embodiments, the first markdown (parameter) value for an item (i.e. a physical object) at a geographic location is determined using a Bayesian Network algorithm.

An initial inventory of items Iₒ to be placed on markdown in a store is determined either using historical average or an accurate value Iₒ existing in the store is passed by the store associate on daily basis to the calculation system, this is used as an input to the Bayesian Network algorithm to estimate first markdown price for the item store combination.

Any consumer response to a markdown value being offered is uncertain since no system information is available for the first markdown of the day, heuristic methods or machine learning methods are used to determine an appropriate first markdown of the day for an item-store cluster. Because a high number of variables are considered in determining the initial markdown for an item, establishing a rule of thumb is complicated. On the other hand, a machine learning algorithm can be easily used to approximate an initial markdown value while taking into consideration a high number of variables and their historical values.

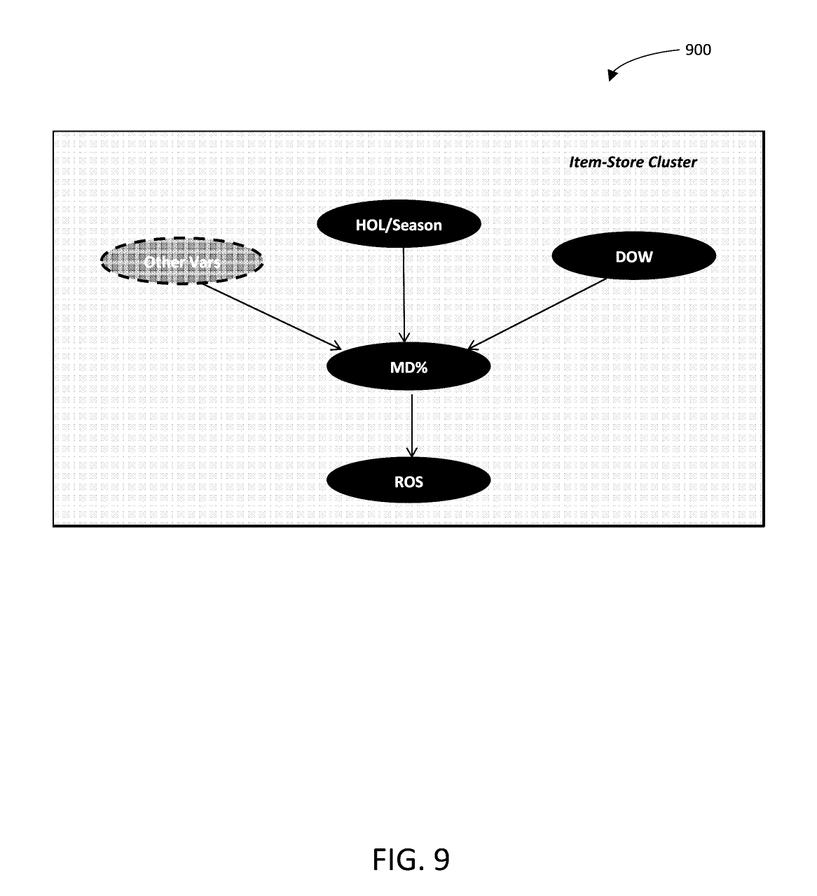

A Bayesian Network based algorithm can be used to determine a rate of sale for an item at a geographic location based on a particular markdown value. An example Bayesian Network model is designed to observe a rate of sale at various markdown values, and taking into consideration variables such as day of the week, season of the year, and any special considerations (such as holidays, special events, etc.). FIG. 9 schematically illustrates an example Bayesian network for dynamically calculating a markdown value or parameter value.

In general, relationships can be summarized using Bayesian Networks. A particular value in the joint distribution can be represented by: P(X₁=x₁, X₂=x₂, . . . , Xₙ=xₙ); Note: X₁, X₂ & z. X₃ are parent nodes of X₄

Using the chain rule of probability theory joint probabilities can be factorized according to:

$$P ( {X}_{1} = {x}_{1} , {X}_{2} = {x}_{2} , … … … . , {X}_{n} = {x}_{n} ) = {\prod }_{i} P ( {x}_{i} \vert {X}_{1} , … , {X}_{i} )$$

The structure of a Bayesian Network implies that probability value of a particular node is conditional on the value of its parent nodes, according to:

$$P ( {X}_{1} = {x}_{1} , {X}_{2} = {x}_{2} , … … … . , {X}_{n} = {x}_{n} ) = {\prod }_{i} P ( {x}_{i} \vert parents ( {X}_{i} ) ) \qquad ( 1 )$$

In an example embodiment, a Bayesian Network model is provided training data to learn the process of determining the first markdown value for an item. The training data can include information related to various variables when a variety of first markdown values are offered for an item at a geographic location. For example, the training data may include various markdown percentages for an item, the day of the week the markdown percentage is offered, and the corresponding rate of sale of item for each of the markdown percentages and the day of the week. Variables considering special events, such as holiday season, may be indicated via a Boolean value. The Bayesian Network model then provides sale per range of period.

The effect of a markdown value can be directly realized by observing the corresponding rate of sale for the item. It is possible that other external factors, beyond the control of a store employee, may impact the rate of sale for item other than the markdown value. In an example embodiment, when training the Bayesian Network model, it is assumed that the impact of other external factors is negligible, and that change in markdown percentage (MD %) is the major factor that directly impacts rate of sale for an item.

It is also assumed that the markdown percentage is impacted by the type of item-store cluster, day of the week, and the occurrence of a particular season or holiday.

The Bayesian Network system can be used to estimate a first markdown value for an item after the Bayesian Network model has been trained. During the training period the system is provided different values of markdown percentages for different days of the week and for different occurrences of holidays or seasons among others. The corresponding impact on rate of sale for an item is then observed and provided to the system. This training exercise is carried over a period of time, and makes up the initial data set to calculate the initial conditional probabilities. Addition of new data to the system over the period of time helps achieve steady state, that is the expected rate of sale for a given markdown percentage becomes nearly constant.

After the Bayesian Network model is trained, it can be used to determine the probability of reaching a particular rate of sale for an item for a particular markdown percentage at a geographic location. For example, the trained Bayesian Network model can be used to determine the probability realizing a rate of sale of 20 units per hour on a Monday when a markdown percentage of 10% is offered. The trained Bayesian Network model can also be used to determine the expected rate of sale per hour on Tuesday when a markdown percentage of 5% is offered with a 99% confidence level. According to the systems and methods described herein, the Bayesian Network model can be used to provide a markdown percentage to achieve a particular rate of sale for an item store combination at a geographic location.

The set of probabilities for achieving a specified rate of sale on a particular day of the week can be used to decide a markdown value to be offered to maximize revenue. To maximize revenue, two conditions should be met. The first condition is that the rate of sale after the markdown value is applied should be greater or equal to rate of sale of units of the same item that are not on markdown, indicating that the product is moving as fast or faster than the natural demand of the item at a geographic location. The required rate of sale may be calculated based on the first condition at block 732 discussed in connection with FIG. 7B. The second condition is that the markdown value should be economically feasible. These conditions can be mathematically represented at a given instance i as follows:

$$\begin{matrix}β \cdot {S}_{n}^{C} \leq {S}_{n}^{md} \& β \leq 1 & Condition ( 1 ) \\ \frac{{P}_{n}^{md} \cdot {S}_{n}^{md}}{β \cdot {P}_{n}^{c} \cdot {S}_{n}^{c}} \geq 1 & Condition ( 2 )\end{matrix}$$

where β is the standardization factor, Sₙ^{md} is the rate of sale after a markdown value is applied, Sₙ^{c} is the rate of sale of units not on markdown, Pₙ^{md} is the price of item after a markdown value is applied, and Pₙ^{c} is the price of the item without the markdown value applied.

The markdown percentage that returns maximum revenue for an item-store cluster is determined using a three-step process explained below.

Step 1—Calculate Conditional Probabilities

According to an example use of the systems and methods described herein, a store employee may be presented with multiple possible markdown percentages or values for an item that he or she can choose from. Each markdown percentage or value is associated with a certain probability of achieving a predefined rate of sale. The predefined rate of sale is computed according to the first condition for maximizing revenue. The probability of achieving the predefined rate of sale based on a markdown value can be represented as below, per equation 1:

$$\{ \begin{matrix}P r ( R O S \geq β \cdot {S}_{n}^{c} \vert M D \% = {y}_{1} , D , H ) \\ P r ( R O S \geq β \cdot {S}_{n}^{c} \vert M D \% = {y}_{2} , D , H ) \\ P r ( R O S \geq β \cdot {S}_{n}^{c} \vert M D \% = {y}_{3} , D , H ) \\ … \\ P r ( R O S \geq β \cdot {S}_{n}^{c} \vert M D \% = {y}_{n} , D , H )\end{matrix} = \begin{matrix}P r ( M D \% = {y}_{n} \\ 0.80 \\ … \\ … \\ … \\ 0.59\end{matrix} \qquad Equation 1$$

where MD % ε(y₁, y₂, y₃, . . . , yₙ) and Pr(ROS≧β·Sₙ^{c}|MD %=y₁, D, H) is the probability of rate of sale (ROS)≧β·Sₙ^{c} given MD % is y₁ and day of the week is D and occurrence of holiday is True. The conditional probabilities may be calculated at block 733 discussed in connection with FIG. 7B.

In one example the overall objective is to recommend a markdown value that yields maximum revenue. It may be observed that as the markdown percentage goes up, the expected rate of sale also increases. An extreme example of this situation would be offering 100% markdown and achieving highest possible rate of sale, however, this will result in low revenues. Therefore, the system does not just rely on probability of achieving predefined sales values for possible markdown percentage but also recommends markdown price that maximizes revenue for any item store combination

Step 2—Reject Loss making Markdowns options

A value for an expected rate of sale, E[X], is calculated for each markdown percentage as below, for a univariate random variable the expected value E[X] can be defined as:

$$E [ X ] = {\sum }_{i = 1}^{∞} {x}_{i} {p}_{i}$$

where x is the value of variable and p is the probability of its occurrence. As a non-limiting example, assume the probability of each instance is equally likely, and also each entry corresponds to an instance where 10% markdown is offered on Mondays. The table below (Table 1) includes data for 10 weeks where the probability is 0.1, and the variable x.p is rate of sale recorded for a time interval.

TABLE 1

| X | p | x · p |
|---|---|---|
| 3 | 0.1 | 0.3 |
| 4 | 0.1 | 0.4 |
| 5 | 0.1 | 0.5 |
| 8 | 0.1 | 0.8 |
| 12 | 0.1 | 1.2 |
| 16 | 0.1 | 1.6 |
| 17 | 0.1 | 1.7 |
| 18 | 0.1 | 1.8 |
| 19 | 0.1 | 1.9 |
| 25 | 0.1 | 2.5 |

The expected rate of sale can then be calculated by: E[X]=Σx.p=0.3+0.4+0.5+0.8+1.2+1.6+1.7+1.8+1.9+2.5=12.7

The expected rate of sale can also be considered the average rate of sale when 10% markdown is offered on Monday. In the above example the rate of sale of 12.7 can be achieved on an average on a Monday when 10% markdown is offered.

After the expected rate of sale is determined, only the markdown percentages which satisfy the second condition to maximize revenue are considered as valid options for recommendation. Using the second condition and the calculated expected rate of sale for a given markdown, equation 2 is derived:

$$\frac{{P}_{n}^{md} \cdot E ( {S}_{n}^{md} )}{β \cdot {P}_{n}^{c} \cdot {S}_{n}^{c}} \geq 1 \qquad Equation 2$$

All markdown value options that satisfy equation 2 are considered to be valid, and can be represented as follows in set b:

Expected Revenue by MDε(Pᵢ^{md}·E(Sᵢ^{md}), Pᵢ₊₁^{md}·E(Sᵢ₊₁^{md}), . . . , Pᵢ₊ₖ^{md}·E(Sᵢ₊ₖ^{md})) (b) set b

The markdown value options may be filtered based on the second condition at block 734 discussed in connection with FIG. 7B.

Step 3—Finalize Markdown Percentage Based on Probabilities

The markdown percentage with the highest probability value in set b is then selected. Though this selections may not provide a global maximum, that is the best possible maximum revenue out of the options available, it will provide local maxima that has the highest probability of occurrence of the expected rate of sale.

### Methodology to Estimate Nth Markdown Parameter Value (Subsequent Markdown During the Same Day)

The functionalities described below may be implemented in one or more components of system 800 shown in FIGS. 8A and 8B. The objective is to determine best markdown price to maximize revenue and minimize waste for any item in any store at any given point of the day.

The conventional methods for applying a markdown value utilizes static tables that contain department level and item level rules defining a percentage reduction to apply to an item based on the day of the week, time of the day and the number of items being marked down. These static tables are updated periodically.

The systems and method described herein include markdown calculations that are provided in an algorithmic solution that enables dynamic real time calculation of a markdown value for any item in any store at any given point of the day. These calculations use revenue maximization to identify the best markdown value. The calculations do not rely on demand models, but rather utilizes real-time data inputs such as sales forecast of marked down items, required rate of sale, POS sales data, critical ratios (described below), current price, and the like. The algorithm takes into consideration various sets of data, including static data such as store information, store format (Supercenter versus To-Go), store size, day of the week, store department, similar items, markdown history, item-store elasticity, seasonality and live/dynamic data such as rate of sale, current to be marked down inventory level, time since last markdown, waste deadline, expiry date and revenue potential.

As discussed above, some embodiments provide for a markdown alert based on inventory levels, current rate of sale as reported by point-of-sale systems in the store, expiration time of an item, and seasonal profiles.

To enable the system to provide accurate markdown (parameter) values to maximize revenue, historical markdown data available from various store databases is used to understand price elasticity and sell through rate patterns. Further, expiring inventory data is made available to the system at the start of the day to generate alerts and calculate any subsequent markdown values. In the store, an employee moves the items on markdown to separate shelves because clearance perception impacts sales potential. In some embodiments, in case separate shelves are not available or full the items are kept in the run with full price items. In some embodiments, if there is an absence of data for an item, then data available for similar items (items sold at same markdown rate) is used in the algorithm.

The method for calculating the markdown values may be understood as having static components and dynamic components. The static component may employ a one-time process that is used during by the dynamic component. The dynamic component may involve calculation of actual markdowns for an item based on continuously changing factors, such as, rate of sale, inventory levels, and time period.

Stage 1 (Cluster Analysis)

In an example the first step may involve calculations is to determine an item-store cluster to apply a consistent markdown strategy for items and stores that exhibit similar behavior. Generating item-store clusters may make the system more efficient because it would result in less data to maintain, and also decreases the number of computations required. The item-store clusters are determined by splitting all stores into clusters or groups based on their relevant attributes, such as store location, store format, store size, and the like. In a store cluster, the items are grouped together based on their similar attributes, behavior (in terms of sale), and associated store department. This provides a unique combination of item and store, which is referred to herein as an item-store cluster. In some embodiments the cluster analysis to group item store combination together may not be required as they may be considerably different to warrant markdown value recommendation at item store level

Stage 2 (Statistical Analysis)

The second step is to determine a set of possible successful markdown (parameter) values, which helps the system to focus on only those markdown strategies that have the potential to maximize revenue. For each item-store cluster, historical markdown data is used to determine allowable markdown percentage values. Markdown values for bundled items (linksave), variable weight items, and other specialty items is calculated independently of other items to ensure that unique factors and results are accurately reflected. In case historical information is not available, all possible markdown options from 1% to 99% are considered.

Stage 3 (Inventory Forecast)

The third step is to forecast inventory which helps the system in determining the timing of the markdown, and can also provide markdown alerts. The end of the day inventory (n) is estimated, the inventory (f) for an item at the end of each time period (j) is forecasted based on the period's actual inventory and rate of sale achieved in the period. This step is described in more detail below.

Stage 4 (MD Viability tables)

In the fourth step, the economically feasible markdown options are identified. A default critical ratios (CR) is calculated to find the economic feasibility. For example, there may be two economically feasible markdown strategies at the end of period 1 for inventory ratio 0.92. The default critical ratio is used for priming the system. This step is described in more detail below.

Stage 5 (Revenue Maximization)

In the fifth step, the best markdown price is selected for revenue maximization among the economically viable markdown options identified in step four, as described in more detail below.

Stage 6 (Auto C-Ratio Correction)

In the sixth step the critical ratios in the static tables are updated on a daily basis based on the actual rate of sale for an item. Data related to the actual rate of sale after a markdown value is applied is used to forecast the next day expected critical ratios based on a single exponential forecast method. The critical ration may be calculated and updated by blocks 840-844 described in connection with FIG. 8B.

In some embodiments, factors such as customer quality perception and desirability of product on markdown are assumed to be reflected in historical item performance and behavior and are not separately accounted for in the equations. In other embodiments, these factors may be taken into consideration in the equation separately.

In some embodiments, the first markdown value for an item may be determined by a store employee, and the above calculations are used to calculate the subsequent markdown values for the item. In other embodiments, the first markdown value for an item is determined using the Bayesian Network algorithm described above.

Markdown Calculation

In order to understand the calculations, assume that a day is divided into n equal periods. In the method described above, an estimate for the end of day n inventory is forecasted for an item at the end of every period j based on that period's actual inventory. The subsequent markdown (parameter) value calculations may be implemented in blocks 835-837 described in connection with FIG. 8B.

Forecast for end of day inventory estimated at the end of period j can be represented as:

f(n,Iⱼ,I₀,F_{c})=Iⱼ·F_{cj+1}, F_{cj+2}, . . . , F_{cj+n}=Iⱼ·(F_{c})^{n-j}

where Iⱼ is available inventory at the end of period j, n is the length of selling period, F_{c} is a proportionality factor, and I₀ is the inventory at the start of the day.

The proportionality factor F_{c} can be estimated for any period as follows:

$${F}_{c} = {( {∐}_{k = 1}^{j} \frac{{I}_{k}}{{I}_{k - 1}} )}^{\frac{1}{j}} \& 0 < {F}_{c} \leq 1 or$$

$${F}_{c} = {( \frac{{I}_{1}}{{I}_{0}} , \frac{{I}_{2}}{{I}_{1}} , \frac{{I}_{3}}{{I}_{2}} , \frac{{I}_{4}}{{I}_{5}} , … , \frac{{I}_{j}}{{I}_{j - 1}} )}^{\frac{1}{j}} = {( \frac{{I}_{j}}{{I}_{0}} )}^{\frac{1}{j}}$$

The above generalization is consistent with the observation that for j=0 at the start of the day, F_{c}=1.

The effect of a store's decision to markdown at the end of period j, from price Pₑ to P_{md} should yield an increase in sales in the consecutive period j+1. If S^{e} to S^{md} are the quantity sold at pre-markdown and markdown prices respectively then the sales volume post markdown is expected to be greater than the pre-markdown.

S^{md}ⱼ₊₁≧S^{e}ⱼ₊₁ (1) Equation b

Sales can be represented as the difference between the start of period inventory and end of period inventory as follows:

S^{e}ₙ₋ⱼ=Iₙ₋ⱼ−Iₙ₋ⱼ*Fₑ^{n-j} (c) Equation c

At period j+1 (j+1) equation c above can be represented as:

S^{e}ⱼ₊₁₋ⱼ=Iⱼ₊₁₋ⱼ−Iⱼ₊₁₋ⱼ*Fₑ^{j+1-j}=I₁−I₁*Fₑ¹ (d) Equation d

Substituting equation d in equation b, we get

$$\frac{{F}_{e}}{{F}_{md}} \geq 1 \qquad Condition 1$$

As discussed above, this is a necessary condition, but not sufficient for selecting a markdown value according to the systems and methods described herein. A sufficient condition that is economically viable also takes into account revenue maximization. To determine the sufficient condition that warrants a markdown, the revenue expected to materialize during the remaining selling time or n−j periods should be higher post markdown. This can be explained mathematically as

P^{md}*S^{md}ₙ₋ⱼ≧P^{e}*S^{e}ₙ₋ⱼ=P^{md}*Iⱼ(1−(F_{md})ₙ₋ⱼ≧P^{e}*Iⱼ(1−(Fₑ)ₙ₋ⱼ & 0<F_{md}≦1 (e) Equation (e)

Now, a sufficient condition of economic viability of markdown can be given as:

$$\frac{{P}_{md}}{{P}_{e}} \geq 1 - {( {F}_{e} )}_{n - j} \qquad Condition 2$$

As described above, the referenced conditions are conditions used to achieve an economically viable markdown. These conditions do not guarantee a markdown that yields maximum revenue.

Since F_{md} is unknown, as a markdown value has still not been selected, re-arranging equation (e), gives us F_{md} as a function of known variables. After generalization, the sales volume ratio is found for period j to j+1 (with price change from Pₑ to P_{md}), to be equal or greater to certain critical ratios for the markdown strategy to be economically feasible. The sale volume ratio is as below:

$$\begin{matrix}Equation ( f ) & \\ \begin{matrix}\frac{{s}_{j + 1}^{md}}{{s}_{j + 1}^{e}} = \frac{{I}_{1} - {I}_{1} * {F}_{md}}{{I}_{1} - {I}_{1} * {F}_{e}} \geq ρ \\ = \frac{1 - {[ 1 - \frac{{( 1 - \frac{{I}_{j}}{{I}_{0}} )}^{\frac{n - j}{j}}}{\frac{{P}_{md}}{{P}_{e}}} ]}^{\frac{1}{n - j}}}{1 - {( \frac{{I}_{j}}{{I}_{0}} )}^{\frac{1}{j}}}\end{matrix} & ( 2 )\end{matrix}$$

The default critical ratio (CR) from equation (f) can be tabulated as a function of price ratio,

$$\frac{{P}_{md}}{{P}_{e}}$$

and inventory ratio,

$$\frac{{I}_{j}}{{I}_{0}}$$

at any given period J to find the economic feasibility of a markdown strategy.

TABLE 2
Critical Ratio Table

| Item group - | | | | | | |
|---|---|---|---|---|---|---|
| Store Group | | | | | | |
| 102423456 | Period 1 | | | Period 2 | | |
| Inventory ratios | Markdown % values | | | Markdown values | | |
| (Ij/I0) | 10 | 30 | 75 | 10 | 30 | 75 |
| 0.95 | 1.11 | 1.22 | 2.56 | 1.45 | 1.56 | 2.89 |
| 0.92 | 1.25 | 1.45 | | 1.87 | 1.78 | 2.92 |
| 0.88 | 1.38 | | | 1.98 | 1.99 | |
| 0.75 | | | | 2.67 | | |

Addition of Limiting Conditions on Critical Ratio for Cannibalization

In some embodiments, the above conditions are modified to account for loss dues to cannibalization. The cannibalization factors may be applied at block 845 discussed in connection with FIG. 8B. The above calculations are valid if no parallel replenishment is done, normally for slow moving items, end of season sale etc. For a fresh product, a store may choose to sell the latest (fresh) stock at normal price alongside the older product (older stock) on a markdown price, leading to availability of the same product at different prices with different use-by-dates. The critical ratio in equation (f) is modified to account for the effects of parallel replenishment.

Three different types of scenarios can be observed. One is where the stock of an item that is on markdown is selling slower than the stock that is not on markdown down. This may mean that the markdowns offered are not as effective as they should be even though there is high demand observed for higher priced stock. It may also mean that the customer prefers a fresher stock and that market acceptability of the product is low, and that not enough stock with markdown is available.

Another scenario that may be observed is that the stock of an item on markdown is selling at a similar pace to the stock that is not on markdown down.

The last scenario that may be observed is that stock on markdown is selling faster than the stock that is not on markdown down. It could mean that the stock on markdown may be cannibalizing the regular sales of the item, and that the consumer finds more value in the product when it is priced lower.

The three scenarios described above can be represented mathematically as below:

βSₙ₋ⱼ^{N}≧σSₙ₋ⱼ^{MD} & β≦1 (3) Equation (g)

σₘᵢₙ≦σ≦σₘₐₓ

where β is the same standardization factor, range for σ depends on the type of product, item-store clusters, and business requirement,

Sₙ₋ⱼ^{N}=Normal rate of sale of items at actual price at time n−j is the normal rate of sale of items at actual price at time n−j.

Ideally, the rate of sale of items on markdown should be as high as possible with minimal cannibalization. It is practically not possible to avoid cannibalization, but it may be possible to restrict it by setting acceptable ranges of critical ratios. A balance is needed between the rate of sale of items on markdown and rate of sale of items not on markdown, while fulfilling the objective of liquidating the markdown stock.

From equation (g) and (c) it can be seen that

$$\begin{matrix}Equation ( h ) & \\ 1 \leq \frac{β \cdot {I}_{n - j \hat{}}}{σ \cdot {I}_{n - j}} ( \frac{1 - {F}_{N}^{n - j}}{1 - {F}_{MD}^{n - j}} ) & ( 4 )\end{matrix}$$

and using

$${F}_{N} = {( \frac{{I}_{j}}{{I}_{0}} )}^{\frac{1}{j}}$$

from (b) and rearranging equation (h), the below equation is derived:

$$\begin{matrix}Equation ( i ) & \\ λ = \frac{1 - {[ 1 - \frac{{( 1 - \frac{{I}_{j}}{{I}_{0}} )}^{\frac{n - j}{j}}}{\frac{{P}_{md}}{{P}_{e}}} ]}^{\frac{1}{n - j}}}{1 - {( \frac{{I}_{j \hat{}}}{{I}_{0 \hat{}}} )}^{\frac{1}{j}}} \cdot ( \frac{σ \cdot {I}_{n - j}}{β \cdot {I}_{n - j \hat{}}} ) & ( 5 )\end{matrix}$$

where I_{n-ĵ} is inventory of items at actual price at time n−j.

With the limits defined in equation (g) and (i), the critical ratio ρ can be controlled as follows: λₘᵢₙ≦ρ≦λₘₐₓ.

Equation (i), can be used to calculate the limits of critical ratio, which is based on markdown price

$$\frac{{P}_{md}}{{P}_{e}} ,$$

inventory ratio

$$\frac{{I}_{j}}{{I}_{0}}$$

of stock or item on markdown, and the ratio of inventory on markdown price and inventory on actual price

$$\frac{{I}_{n - j}}{{I}_{n - j \hat{}}} .$$

The lower and upper limit can be controlled by changing a.

Revenue can be maximized using the below equation for an economically feasible markdown in a given period:

Max(P_{md1}*ROS_{md1}, P_{md2}*ROS_{md2}, . . . , P_{mdn}*ROS_{mdn}) (6) Equation (j)

where expected rate of sale on markdown ROS_{md} can be defined as:

Rₙ^{E}=Rₙ₋₁*ρₙ^{md} (7) Equation (k)

Auto-Correction of Critical Ratios Based on Real Time Data

The critical ratio static tables in the system is updated at certain defined intervals. The tables are updated with the corrected values of critical ratios for a given markdown value at a given inventory ratio. The system corrects itself based on logic of a single exponential forecast.

The system needs correction because the derived critical ratios formulae calculates only theoretical increase in rate of sale and is set as a default value for priming the system, the additional steps described below account for the change in default critical ratio values based on actual rate of sale of the item observed in a given store at a given time.

Step 1

The critical ratio at a markdown value gives an estimate of increase in rate of sale over the current rate of sale. The expected rate of sale when the markdown is offered can be defined as:

Rₙ^{E}=Rₙ₋₁*ρ_{b}^{md} (7) Equation (l)

In real scenario, the actual realized rate of sales may not equal to the expected rate of sale. Therefore, the critical ratios in the system are corrected based on the actual realized rate of sale. All tables start with the base/default values for critical ratio (equation f), which are revised based on the actual rate of sale observed against a markdown value offered for an item store combination.

Percentage deviation of rate of sale is then calculated as:

$$\begin{matrix}Equation ( m ) & \\ {R}^{\hat{}} = \frac{{R}_{n} - {R}_{n}^{E}}{{R}_{n - 1}} & ( 8 )\end{matrix}$$

Therefore, the new critical ratio is:

i.e. ρₙ^{̂}=ρₙ^{md}+R^{̂} (9) Equation (n)

New ρₙ will be updated in the table during next revision cycle, which is auto scheduled to occur daily.

The new critical ration ρₙ is updated in the table at a specified frequency K (for example, daily), and for a length of selling period n (for example, hourly). Rₙ^{E} is the expected rate of sale at period n, where

$$\frac{{I}_{j}}{{I}_{0}}$$

is constant, R^{c} is the required critical rate of sale, Rₙ₋₁ is the received rate of sale at period n−1, and ρₙ^{md} is the critical ratio at a given markdown value and period n.

Step 2

The revision tables can be visualized as Period*Day/Week matrix (K*n)

$$\overbrace{\begin{matrix}k & n & n + 1 & … & n + 9 & n + j \\ k + 1 & n & … & … & … & n + j \\ k + 2 & n & … & … & … & n + j \\ & & & & & \\ K + 8 & n & … & … & … & n + j \\ k + 9 & n & … & … & … & n + j \\ k + j & n & n + 1 & … & n + 9 & n + j\end{matrix} \}}^{Period} Day / week$$

The equation below provides the new updated values of critical ratio based on the latest critical ratio. The behavior of critical ratios can be assumed as random during the learning period and single exponential forecasting method can be used to update expected critical ratio in tables for a given period and markdown quantity.

ρₖ₊₁=αρₖ^{̂}+(1−α)ρₖ (10) Equation (o)

To understand the above algorithm, assume, as a non-limiting example, n=3, Rₙ^{E} is expected rate of sale at period n, where

$$\frac{{I}_{j}}{{I}_{0}}$$

is constant and equals 0.95. The received/realized rate of sale at period n−1 is 5 units/hour. The critical ratio at a given markdown value and period n is ρₙ^{md}=1.17.

Then using equation (1), Rₙ^{E}=Rₙ₋₁×ρₙ^{md}=5×1.17=5.85 units/hour. At n=3, the real rate of sale can be calculated and the error is estimated.

Assume that actual rate of sale Rₙ=6 then using equation (m) the percentage deviation of rate of sale is:

$$\begin{matrix}{R}^{\hat{}} = \frac{6 - 5.85}{5} \\ = \frac{0.15}{5} \\ = 0.03\end{matrix}$$

Using equation (n), the new critical ratio is calculated as:

ρₙ^{̂}=1.17+0.03=1.20

TABLE 2
Critical Ratio ρ at k

| Item group - | | | | | | |
|---|---|---|---|---|---|---|
| Store Group | | | | | | |
| 102423456 | Period 1 (n = 3) | | | Period 2 (n + 1) | | |
| Inventory | Markdown % values | | | Markdown values | | |
| ratios (Iⱼ/I₀) | 10 | 30 | 75 | 10 | 30 | 75 |
| 0.95 | 1.17 | 1.22 | 2.56 | 1.45 | 1.56 | 2.89 |
| 0.92 | 1.25 | 1.45 | | 1.87 | 1.78 | 2.92 |
| 0.88 | 1.38 | | | 1.98 | 1.99 | |
| 0.75 | | | | 2.67 | | |

TABLE 3
Critical Ratio ρ at k + 1

| Item group - | | | | | | |
|---|---|---|---|---|---|---|
| Store Group | | | | | | |
| 102423456 | Period 1 (n = 3) | | | Period 2 (n + 1) | | |
| Inventory | Markdown % values | | | Markdown values | | |
| ratios (Iⱼ/I₀) | 10 | 30 | 75 | 10 | 30 | 75 |
| 0.95 | 1.18 | 1.22 | 2.56 | 1.45 | 1.56 | 2.89 |
| 0.92 | 1.25 | 1.45 | | 1.87 | 1.78 | 2.92 |
| 0.88 | 1.38 | | | 1.98 | 1.99 | |
| 0.75 | | | | 2.67 | | |

As shown in tables 2 and 3 the critical ratio value for Period 1, 10% markdown, 0.95 inventory ratio is updated overnight from 1.17 to 1.18.

As a non-limiting example, assume α=0.5 then from equation (o), the critical ratio can be forecasted as follows: ρₖ₊₁=0.5*1.20+0.5*1.17=1.185

Table 4 below gives an example of corrections made to ρₖ₊₁ with each iteration for a given period n and

$$\frac{{I}_{j}}{{I}_{0}}$$

TABLE 4

| K | ρₖ | ρₙ\hat{ } | ρₖ₊₁ | Error |
|---|---|---|---|---|
| 1 | 1.17 | 1.20 | 1.18 | +0.03 |
| 2 | 1.18 | 1.06 | 1.88 | −0.13 |
| 3 | 1.88 | 1.05 | 1.11 | −0.06 |
| . | | | | |
| . | | | | |
| . | | | | |
| k | — | — | — | — |

The value α can be adjusted based on business logic or as α gets closer to 1, higher weight is given to recent actual ρ values.

The systems and methods described here also provide for markdown alerts. The markdown alert may be automatically generated when a marked down item is not producing an anticipated rate-of-sale. Alerts may be generated by assessing loss-of-revenue, that is, by comparing the expected rate-of-sale with the actual rate-of-sale for a marked down item, in a given store, over a pre-determined period of time. In some embodiments, an alert is only generated for a physical object that has been marked down. The alerts may include the following: item number and description, item location, current price, original price, the current markdown iteration (where applicable) and narrative instructing a user to initiate another markdown.

In this manner, systems and methods are provided for dynamically calculating a value for a physical object based on real-time data, such as hourly or daily sales forecast, rate-of-sale for regularly priced items, sales data from point-of-sale systems, self-cannibalization effects, and other variables. The time period for adjusting a parameter value or markdown value is flexible and is dynamically determined based on various factors, such as realized or actual rate-of-sale and input from a store associate. As such, the time interval between two parameter value adjustments (markdown value adjustment) is not fixed and can be different every day, for a store, and for an item in the store. Similarly, the time the first parameter value is set can also be different each day, for a store, and for an item in the store. As described above, the dynamic value calculation tool also takes into consideration input from a store associate when calculating a parameter value. The store associate may provide input related to the following: quantity of items that need to be marked down, associate decision that item is marked down before the marked down time recommended by the dynamic value calculation tool, number of damaged items, reason code for damaged items, interruption in supply chain, quantity of bundled-items available at the start of the day, and the like. The process of calculating a parameter value is initiated and controlled by a particular store, and not by a managing store or supervisory entity, because only the store associates are aware of particular circumstances at the store.

Traditional systems tend to group items and stores when calculating parameter values. However, as described above, each store, and each item in each store behaves differently. Therefore, the dynamic value calculation tool calculates parameter values for each item—store combination, and does not calculate a parameter value for a group of stores or a group of items. In some embodiments, the dynamic calculation tool can be configured to calculate parameter values for a combination of an item—store grouping, an item grouping—store or an item grouping—store grouping. Additionally, the dynamic value calculation tool enables parameter value calculations for a new item at a store, or items at a new store that may not have data available for historical parameter values. This may be achieved by categorizing the new item or new store as a similar item or store and using the historical data available for the similar item or store.

The dynamic value calculation tool is designed to work for a continuous product line with constant replenishment. For example, fresh produce are constantly replenished at a store, and have a short shelf-life. Under some circumstances, the same product may have items on the shelf that have different expiration dates and therefore different price values. This causes self-cannibalization, and the dynamic value calculation tool takes this into consideration when calculating a parameter value and recommending a time period for adjusting the parameter value.

The dynamic value calculation tool also works for product lines that have active and inactive items during a year. Some products may be inactivated for particular seasons of the year (for example, Christmas trees may be an active product during Christmas season, but is inactivated for the other seasons). In some embodiments, when a product is activated for the next season, it is assigned a new item code. The dynamic value calculation tool is designed to realize the change in item codes.

The system and methods described herein work with various scenarios at a store. For example, if an item is scheduled to expire today (present day), the following information is provided to the dynamic value calculation tool: item code, department number, store number, current price, quantity of items expiring, the number of markdown iteration, expiration date (today), and time stamp of when information is provided. As another example, if an item is to be marked down before the expiry date, the following information is provided to the dynamic value calculation tool: item code, department number, store number, current price, quantity of items expiring, the number of markdown iteration, expiration date, and time stamp of when information is provided. In another example, if the item is damaged, then the following information is provided: item code, department number, store number, current price, quantity of items expiring, the number of markdown iteration, expiration date, severity of damage, and time stamp of when information is provided. If the item damaged is a clothing product, then a damage reason code is also provided. Another scenario supported by the dynamic value calculation tool is bundled-items, where the following information is provided to the tool: item code, department number, store number, current price, quantity of items expiring, the number of markdown iteration, expiration date, time stamp of when information, bundled-item price and quantity is provided. As another example, the dynamic value calculation tool supports variable weight items, where the following information is provided: item code, department number, store number, current price, quantity of items expiring, the number of markdown iteration, expiration date, time stamp of when information is provided, sub-quantity, and sub-weight. Sub-weight and sub-quantity may refer to a portion of the weight of a product that is sold based on weight. For example a variety of cheese may be priced as $0.50 per 1 pound, the cheese may be cut into blocks of smaller weight units for example 1.5 ounces, 3 ounces, 4 ounces etc. and sold in smaller weight units. The number of units that the 1 pound cheese is divided into is the sub-quantity, and the sub-weight is weight of the smaller portions of cheese. A split pack scenario is also supported where the following information is provided: item code, department number, store number, current price, quantity of items expiring, the number of markdown iteration, expiration date, time stamp of when information is provided, unit pack quantity, and sellable quantity. The dynamic value calculation tool also supports scenarios where the bundled-item is damaged, a spilt-pack item is damaged, and a variable weight item is damaged.

FIG. 10 illustrates a network diagram depicting a system 1000 for implementing the dynamic value calculation tool, according to an example embodiment. The system 1000 can include a network 1005, multiple devices, for example, device 1010, device 1020, multiple servers, for example, server 1030, server 1035, first database(s) 1040, and second database(s) 1050. Each of the devices 1010, 1020, servers 1030, 1035, and database(s) 1040, 1050 is in communication with the network 1005.

In an example embodiment, one or more portions of network 1005 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The devices 1010,1020 may comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, tablets, netbooks, and the like.

In an example embodiment, the device 1010, 1020 may be one or more terminals, for example, a point-of-sale terminal, including an optical scanning device. In this case, the device 1010, 1020 may comprise, but is not limited to, cash registers, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, smartphones, tablets, netbooks, and the like. The point-of-sale terminal 1010, 1020 is part of a store infrastructure and aid in performing various transactions related to sales and other aspects of a store. Being part of a store's infrastructure, the point-of-sale terminal may be installed within the store or they may be installed or operational outside of the store. For example, the point-of-sale terminal may be a mobile device that a store employee can use outside of the store to perform transactions or other activities. In another example, the point-of-sale terminal may be a kiosk installed outside the store. Similarly, the point-of-sale terminal may be a mobile device that can be used within the store, and is not physically installed or attached to one particular location within the store.

The device 1010, 1020, as a point-of-sale terminal may also include various external or peripheral devices to aid in performing sales transactions and other duties. Examples of peripheral devices include, but are not limited to, barcode scanners, cash drawers, monitors, touch-screen monitors, clicking devices (e.g., mouse), input devices (e.g., keyboard), receipt printers, coupon printers, payment terminals, and the like. Examples of payment terminals include, but are not limited to, card readers, pin pads, signature pads, signature pens, Square™ registers, LevelUp™ platform, cash or change deposit devices, cash or change dispensing devices, coupon accepting devices, and the like.

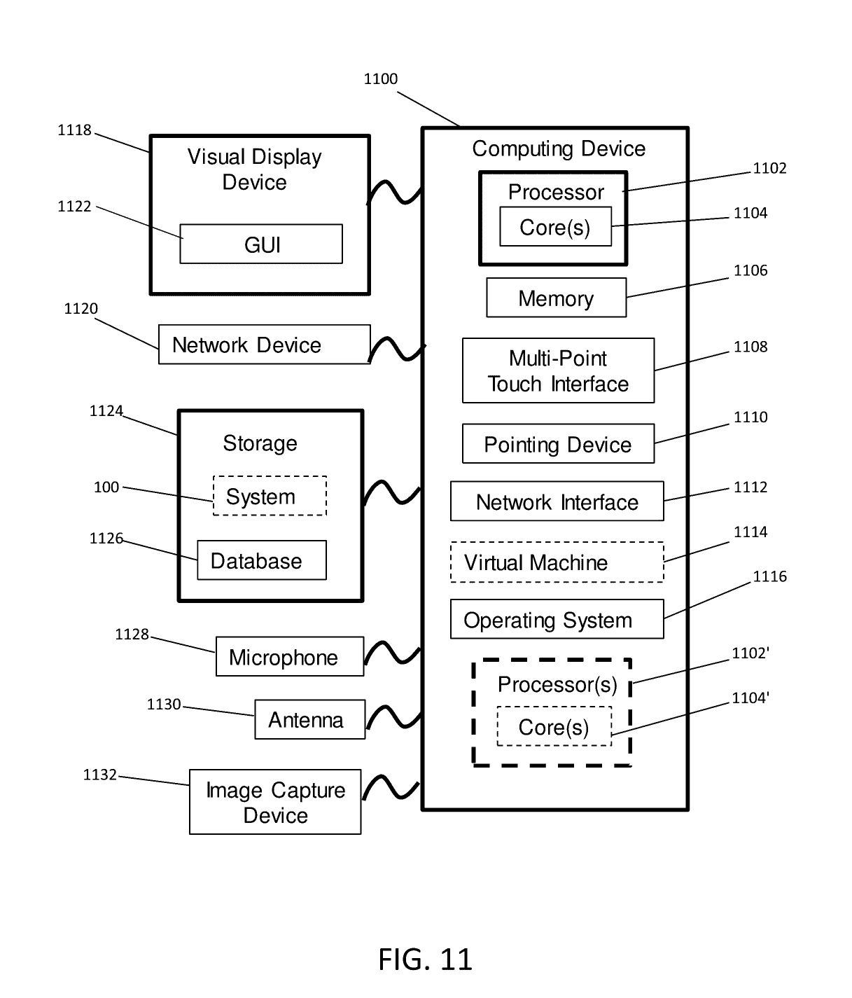

Each of devices 1010, 1020 can include one or more components described in relation to computing device 1100 shown in FIG. 11. Each of devices 1010, 1020 may connect to network 1005 via a wired or wireless connection. Each of devices 1010, 1020 may include one or more applications such as, but not limited to, a point-of-sale application, an inventory application, a dynamic value calculation tool, and the like. In an example embodiment, the devices 1010, 1020 may perform all the functionalities described herein.

In other embodiments, the dynamic value calculation tool may be included on the device 1010, 1020, and the servers 1030, 1035 performs the functionalities described herein. In yet another embodiment, the device 1010, 1020 may perform some of the functionalities, and servers 1030, 1035 performs the other functionalities described herein.

Each of the database(s) 1040, 1050, and servers 1030, 1035 is connected to the network 1005 via a wired connection. Alternatively, one or more of the database(s) 1040, 1050, and servers 1030, 1035 may be connected to the network 1005 via a wireless connection. Although not shown, server 1030, 1035 can be (directly) connected to the database(s) 1040, 1050. Servers 1030, 1035 comprises one or more computers or processors configured to communicate with devices 1010, 1020 via network 1005. Servers 1030, 1035 hosts one or more applications or websites accessed by devices 1010, 1020 and/or facilitates access to the content of database(s) 1040, 1050. Database(s) 1040, 1050 comprise one or more storage devices for storing data and/or instructions (or code) for use by servers 1030, 1035, and/or devices 1010, 1020. Database(s) 1040, 1050, and/or servers 1030, 1035, may be located at one or more geographically distributed locations from each other or from devices 1010, 1020. Alternatively, database(s) 1040, 1050 may be included within servers 1030, 1035.

FIG. 11 is a block diagram of an exemplary computing device 1100 that may be used to implement exemplary embodiments of the dynamic value calculation tool 100 described herein. The computing device 1100 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1106 included in the computing device 1100 may store computer-readable and computer-executable instructions or software for implementing exemplary embodiments of the dynamic value calculation tool 100. The computing device 1100 also includes configurable and/or programmable processor 1102 and associated core 1104, and optionally, one or more additional configurable and/or programmable processor(s) 1102′ and associated core(s) 1104′ (for example, in the case of computer systems having multiple processors/cores), for executing computer-readable and computer-executable instructions or software stored in the memory 1106 and other programs for controlling system hardware. Processor 1102 and processor(s) 1102′ may each be a single core processor or multiple core (1104 and 1104′) processor.

Virtualization may be employed in the computing device 1100 so that infrastructure and resources in the computing device may be shared dynamically. A virtual machine 1114 may be provided to handle a process running on multiple processors so that the process appears to be using only one computing resource rather than multiple computing resources. Multiple virtual machines may also be used with one processor.

Memory 1106 may include a computer system memory or random access memory, such as DRAM, SRAM, EDO RAM, and the like. Memory 1106 may include other types of memory as well, or combinations thereof.

A user may interact with the computing device 1100 through a visual display device 1118, such as a computer monitor, which may display one or more graphical user interfaces 1122 that may be provided in accordance with exemplary embodiments. The computing device 1100 may include other I/O devices for receiving input from a user, for example, a keyboard or any suitable multi-point touch interface 1108, a pointing device 1110 (e.g., a mouse), a microphone 1128, and/or an optical scanning/capturing device 1132 (e.g., a camera, scanner, barcode reader, QR code reader). The multi-point touch interface 1108 (e.g., keyboard, pin pad, scanner, touch-screen, etc.) and the pointing device 1110 (e.g., mouse, stylus pen, etc.) may be coupled to the visual display device 1118. The computing device 1100 may include other suitable conventional I/O peripherals. As described herein, the optical scanning device 1132 can scan optical machine-readable representations associated with physical objects so that the computing device 1100 can receive and process the identifier.

The computing device 1100 may also include one or more storage devices 1124, such as a hard-drive, CD-ROM, or other computer readable media, for storing data and computer-readable instructions and/or software that implement exemplary embodiments of the dynamic value calculation tool 1100 described herein. Exemplary storage device 1124 may also store one or more databases for storing any suitable information required to implement exemplary embodiments. For example, exemplary storage device 1124 can store one or more databases 1126 for storing information, such horizontal markdown history data, vertical markdown history data, real-time point-of-sale data, inventory levels, sales history, elasticity data, item-store cluster information, Bayesian Network algorithm data, and other data and information to be used by embodiments of the system 100. The databases may be updated manually or automatically at any suitable time to add, delete, and/or update one or more items in the databases.

The computing device 1100 can include a network interface 1112 configured to interface via one or more network devices 1120 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 1100 can include one or more antennas 1130 to facilitate wireless communication (e.g., via the network interface) between the computing device 1100 and a network. The network interface 1112 may include a built-in network adapter, network interface card, PCMCIA network card, card bus network adapter, wireless network adapter, USB network adapter, modem or any other device suitable for interfacing the computing device 1100 to any type of network capable of communication and performing the operations described herein. Moreover, the computing device 1100 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 1100 may run any operating system 1116, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 1116 may be run in native mode or emulated mode. In an exemplary embodiment, the operating system 1116 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A method of dynamically reconfiguring parameter values in a computing system based on scanning of an optical machine-readable identifier associated with physical objects, the method comprising:
determining, by a server, a value of a parameter associated with physical objects, the value of the parameter being stored in a first database and being associated with the physical objects for a first time period at one or more specified geographic locations;
scanning, by one or more terminals including an optical scanning device at the one or more specified geographic locations, an optical machine-readable identifier associated with the physical objects during the first time period, the value of the parameter being retrieved from the first database in response to the scanning;
recording, by the terminal in a second database, information related to a quantity of times the optical machine-readable identifier is scanned at the one or more geographic locations during the first time period;
retrieving the information recorded in the second database for the first time period;
analyzing a rate at which the optical machine-readable identifier was scanned during the first time period based on the information;
when the rate is less than a specified rate, determining a subsequent value of the parameter, and a second time period for which the parameter is to be set to the subsequent value, the subsequent value of the parameter and second time period being based at least in part on a predicted response to the subsequent value at the one or more geographic locations during the second time period; and
replacing the value with the subsequent value in the first database for the second time period.

2. The method of claim 1, wherein the value of the parameter is determined using a Bayesian Network algorithm, the Bayesian Network algorithm being based at least in part on historical values of the parameter for the past time periods that correspond to the first time period, a historical quantity of times the optical machine-readable identifier was scanned during the past time periods, historical dates of specific events, and demographic features of the one or more geographic locations.

3. The method of claim 2, wherein the value of the parameter is determined using the Bayesian Network algorithm when the historical quantity of times the optical machine-readable identifier was scanned during the past time periods is not available.

4. The method of claim 1, wherein the predicted response is based, at least in part, on a historical rate at which the optical machine-readable identifier was scanned when the parameter was set to at least one of the previous value, the value, the subsequent value, or a further subsequent value.

5. The method of claim 1, wherein the predicted response is based, at least in part, on a historical rate at which the optical machine-readable identifier was scanned at the one or more geographic locations and demographics of individuals that visit the one or more geographic locations.

6. The method of claim 1, wherein the subsequent value is based at least in part on a percentage by which the subsequent value exceeds a cost to acquire one of the physical objects, a deadline by which the objects must be removed from a display area at the one or more geographic locations, and operating hours of the one or more geographic locations.

7. The method of claim 1, wherein the subsequent value and the second time period are determined based at least in part on a cost of printing and managing price labels for the physical objects.

8. A system for dynamically reconfiguring parameter values in a computing system based on scanning of an optical machine-readable identifier associated with physical objects, the system comprising:
a server;
a first database;
a second database; and
one or more terminals including an optical scanning device;
the server configured to determine a value of a parameter associated with physical objects, the value of the parameter being stored in a first database and being associated with the physical objects for a first time period at one or more specified geographic locations;
the optical scanning device at the one or more terminals used to scan an optical machine-readable identifier associated with the physical objects, the value of the parameter being retrieved from the first database in response to the scanning;
the one or more terminals configured to record in the second database information related to a quantity of times the optical machine-readable identifier is scanned at the one or more geographic locations during the first time period;
the server further configured to retrieve the information recorded in the second database for the first time period, and to analyze a rate at which the optical machine-readable identifier was scanned during the first time period based on the information;
in response to a determination that the rate is less than a specified rate, the server further configured to determine a subsequent value of the parameter, and a second time period for which the parameter is to be set to the subsequent value, the subsequent value of the parameter and second time period being based at least in part on a predicted response to the subsequent value at the one or more geographic locations during the second time period; and
the server further configured to replace the value with the subsequent value in the first database for the second time period.

9. The system of claim 8, wherein the value of the parameter is determined using a Bayesian Network algorithm, the Bayesian Network algorithm being based at least in part on historical values of the parameter for the past time periods that correspond to the first time period, a historical quantity of times the optical machine-readable identifier was scanned during the past time periods, historical dates of specific events, and demographic features of the one or more geographic locations.

10. The system of claim 9, wherein the value of the parameter is determined using the Bayesian Network algorithm when the historical quantity of times the optical machine-readable identifier was scanned during the past time periods is not available.

11. The system of claim 8, wherein the predicted response is based, at least in part, on a historical rate at which the optical machine-readable identifier was scanned when the parameter was set to at least one of the previous value, the value, the subsequent value, or a further subsequent value.

12. The system of claim 8, wherein the predicted response is based, at least in part, on a historical rate at which the optical machine-readable identifier was scanned at the one or more geographic locations and demographics of individuals that visit the one or more geographic locations.

13. The system of claim 8, wherein the subsequent value is based at least in part on a percentage by which the subsequent value exceeds a cost to acquire one of the physical objects, a deadline by which the objects must be removed from a display area at the one or more geographic locations, and operating hours of the one or more geographic locations.

14. The system of claim 8, wherein the subsequent value and the second time period are determined based at least in part on a cost of printing and managing price labels for the physical objects.

15. A non-transitory machine-readable medium storing instructions executable by a processing device, wherein execution of the instructions causes the processing device to implement a method for dynamically reconfiguring parameter values in a computing system based on scanning of an optical machine-readable identifier associated with physical objects, the method comprising:
determining a value of a parameter associated with physical objects, the value of the parameter being stored in a first database and being associated with the physical objects for a first time period at one or more specified geographic locations;
receiving data from scanning an optical machine-readable identifier associated with the physical objects, the value of the parameter being retrieved from the first database in response to the scanning;
recording, in a second database, information related to a quantity of times the optical machine-readable identifier is scanned at the one or more geographic locations during the first time period;
retrieving the information recorded in the second database for the first time period;
analyzing a rate at which the optical machine-readable identifier was scanned during the first time period based on the information;
when the rate is less than a specified rate, determining a subsequent value of the parameter, and a second time period for which the parameter is to be set to the subsequent value, the subsequent value of the parameter and second time period being based at least in part on a predicted response to the subsequent value at the one or more geographic locations during the second time period; and
replacing the value with the subsequent value in the first database for the second time period.

16. The non-transitory machine-readable medium of claim 15, wherein the value of the parameter is determined using a Bayesian Network algorithm, the Bayesian Network algorithm being based at least in part on historical values of the parameter for the past time periods that correspond to the first time period, a historical quantity of times the optical machine-readable identifier was scanned during the past time periods, historical dates of specific events, and demographic features of the one or more geographic locations.

17. The non-transitory machine-readable medium of claim 16, wherein the value of the parameter is determined using the Bayesian Network algorithm when the historical quantity of times the optical machine-readable identifier was scanned during the past time periods is not available.

18. The non-transitory machine-readable medium of claim 15, wherein the predicted response is based, at least in part, on a historical rate at which the optical machine-readable identifier was scanned when the parameter was set to at least one of the previous value, the value, the subsequent value, or a further subsequent value.

19. The non-transitory machine-readable medium of claim 15, wherein the predicted response is based, at least in part, on a historical rate at which the optical machine-readable identifier was scanned at the one or more geographic locations and demographics of individuals that visit the one or more geographic locations.

20. The non-transitory machine-readable medium of claim 15, wherein the subsequent value is based at least in part on a percentage by which the subsequent value exceeds a cost to acquire one of the physical objects, a deadline by which the objects must be removed from a display area at the one or more geographic locations, and operating hours of the one or more geographic locations.
